(19) United States
(12) Patent Application Publication
(10) Pub. No.: US 2026/0330176 A1
(43) Pub. Date: Oct. 22, 2026

(54) SECURITY TAG WITH TEAR-AWAY FEATURE

(71) Applicant: Sensormatic Electronics, LLC, Boca Raton, FL (US)

(72) Inventors: Gilbert FERNANDEZ, JR., Weston, FL (US); Jose Luis FERNANDEZ COUCE, A Coruna (ES); Lauri Johannes HUHTASALO, Tampere (FI); Mario Alberto GARCIA REYES, Boca Raton, FL (US)

(21) Appl. No.: 19/710,346

(22) Filed: Jun. 16, 2026

Related U.S. Application Data
(63) Continuation of application No. PCT/US2024/061363, filed on Dec. 20, 2024.
(63) Continuation of application No. PCT/US2024/061406, filed on Dec. 20, 2024.
(60) Provisional application No. 63/613,046, filed on Dec. 20, 2023.
(60) Provisional application No. 63/613,046, filed on Dec. 20, 2023.
(60) Provisional application No. 63/659,652, filed on Jun. 13, 2024.
(60) Provisional application No. 63/659,672, filed on Jun. 13, 2024.

(51) Int. Cl. G06K 19/077

(52) U.S. Cl. CPC G06K 19/07773

(57) ABSTRACT

Aspects of the present disclosure relates to security tag associated with a plurality of security tags comprising: a sleeve having a first tensile strength, and an inlay having a second tensile strength, the inlay being disposed movably within the sleeve and including, an antenna mounted on the inlay, and a radio frequency identifier (RFID) circuit coupled with the antenna, and a first tab and a second tab each having a third tensile strength, wherein at least one of the first tab or the second tab is configured to detachably couple the security tag with an adjacent one of the plurality of security tags, wherein the first tensile strength is smaller than the second tensile strength and larger than the third tensile strength. Additional aspects include a dispenser of a string of the plurality of security tags, and a process for making the plurality of security tags.

### FIELD

The present application is a bypass continuation of and claims priority to, and the benefit of, International Application Nos. PCT/US 2024/061406, filed Dec. 20, 2024, entitled “SECURITY TAG WITH TEAR-AWAY FEATURE,” and PCT/US 2024/061363, filed Dec. 20, 2024, entitled “SYSTEM AND METHOD OF DISPENSING SECURITY TAGS WITH TEAR-AWAY FEATURE,” both of which in turn claim priority to, and the benefit of, U.S. Provisional Application No. 63/613,046, filed Dec. 20, 2023, entitled “Security Tag,” International Application No. PCT/US2024/061406 further claiming priority to, and the benefit of, U.S. Provisional Application No. 63/659,652 , filed Jun. 13, 2024, entitled “SECURITY TAG WITH TEAR-AWAY FEATURE,” International Application No. PCT/US2024/061363 further claiming priority to, and the benefit of, U.S. Provisional Application No. 63/659,672 , filed Jun. 13, 2024, entitled “SYSTEM AND METHOD OF DISPENSING SECURITY TAGS WITH TEAR-AWAY FEATURE,” the contents of which are hereby incorporated by reference in their entireties.

### FIELD

The present disclosure relates generally to security tags, and more particularly to an electronic article surveillance tag.

### BACKGROUND

Electronic Article Surveillance (EAS) systems are commonly used in retail stores and other settings to prevent the unauthorized removal of goods from a protected area. Typically, a detection system is configured at an exit from the protected area, which comprises one or more transmitters and antennas (“pedestals”) capable of generating an electromagnetic field across the exit, known as the “interrogation zone.” Articles to be protected are tagged with a security tag (such as a radio frequency identification (RFID) and/or an acousto-magnetic (AM) tag), also known as an EAS marker, that, when active, generates a response signal when passed through this interrogation zone. An antenna and receiver in the same or another “pedestal” detect this response signal and generate an alarm.

Additionally, permanent hidden/embedded tags in goods could be used for other purposes, such as, but not limited to, circular economy applications (new business models like renting clothes, or selling second hand clothes with known authenticity and pedigree). In many cases the same tag can be used for multiple purposes: security (anti-theft), circular economy, supply chain management, and/or inventory management.

Thus, improvements in security tags is desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

One or more aspects of the present disclosure include a plurality of security tags, each of the plurality of security tags includes: a sleeve having a first tensile strength, and an inlay having a second tensile strength, the inlay being disposed movably within the sleeve and including, an antenna mounted on the inlay, and a radio frequency identifier (RFID) circuit coupled with the antenna, and a plurality of tabs each having a third tensile strength, each of the plurality of tabs being configured to detachably couple to respective distal ends of the two of the plurality of security tags, wherein the first tensile strength is smaller than the second tensile strength and larger than the third tensile strength.

In an aspect, a plurality of security tags, each of the plurality of security tags comprising: a sleeve having a first tensile strength; and an inlay having a second tensile strength, the inlay being disposed movably within the sleeve and including: an antenna mounted on the inlay; and a radio frequency identifier (RFID) circuit coupled with the antenna; and a plurality of tabs each having a third tensile strength, each of the plurality of tabs being configured to detachably couple opposing ends of two adjacent ones of the plurality of security tags; wherein the first tensile strength is smaller than the second tensile strength and larger than the third tensile strength.

One or more other aspects of the present disclosure include a plurality of security tags, each of the plurality of security tags includes: a sleeve having a first tensile strength, and an inlay having a second tensile strength, the inlay being disposed movably within the sleeve and including, an antenna mounted on the inlay, and a radio frequency identifier (RFID) circuit coupled with the antenna, and a first tab and a second tab of a plurality of tabs each having a third tensile strength, wherein at least one of the first tab or the second tab is configured to detachably couple the security tag with an adjacent one of the plurality of security tags, wherein the first tensile strength is smaller than the second tensile strength and larger than the third tensile strength.

In an aspect, a plurality of security tags, each of the plurality of security tags comprising: a sleeve having a first tensile strength; and an inlay having a second tensile strength, the inlay being disposed movably within the sleeve and including: an antenna mounted on the inlay; and a radio frequency identifier (RFID) circuit coupled with the antenna; and a first tab and a second tab each having a third tensile strength, wherein at least one of the first tab or the second tab is configured to detachably couple the security tag with an adjacent one of the plurality of security tags; wherein the first tensile strength is smaller than the second tensile strength and larger than the third tensile strength.

In a further aspect, a security tag dispenser comprises: a base; an axle extending from the base and configured to hold a spool having a string of a plurality of coupled security tags; a gripper assembly including a pivot member having a gripping flange and a supporting flange; wherein the gripping flange is configured to move between a first position configured to allow relative movement of the string of the plurality of coupled security tags, and a second position configured removably hold a second security tag of the string of coupled security tags; and wherein the supporting flange is configured support a first security tag adjacent to the second security tag on the string of the plurality of coupled security tags, and wherein the supporting flange is configured to transfer a portion of a tensile force applied to the first security tag to cause the gripping flange to move from the first position to the second position.

In another aspect, a security tag system comprises: a plurality of security tags, each of the plurality of security tags comprising: a sleeve having a first tensile strength; and an inlay having a second tensile strength, the inlay being disposed movably within the sleeve and including: an antenna mounted on the inlay; and a radio frequency identifier (RFID) circuit coupled with the antenna; a first tab and a second tab each having a third tensile strength, wherein at least one of the first tab or the second tab is configured to detachably couple the security tag with an adjacent one of the plurality of security tags, wherein the first tensile strength is smaller than the second tensile strength and larger than the third tensile strength; and a security tag dispenser, comprising: a base; an axle extending from the base and configured to hold a spool having a string of the plurality of security tags; a gripper assembly including a pivot member having a gripping flange and a supporting flange; wherein the gripping flange is configured to move between a first position configured to allow relative movement of the string of the plurality of security tags, and a second position configured removably hold a second security tag of the string of the plurality of security tags; and wherein the supporting flange is configured support a first security tag adjacent to the second security tag on the string of the plurality of security tags, and wherein the supporting flange is configured to transfer a portion of a tensile force applied to the first security tag to cause the gripping flange to move from the first position to the second position.

In yet another aspect, a method of making a plurality of security tags, comprising: placing a sensor on a length of material, wherein the sensor comprises an inlay, an antenna mounted on the inlay, and a radio frequency identifier (RFID) circuit coupled with the antenna, wherein the material comprises a fabric, wherein the sensor has a length extending from a first sensor end to an opposing second sensor end; folding a first lengthwise side of the material over to a second lengthwise side of the material to define a sleeve of the material having a top layer and a bottom layer, wherein the sensor is encompassed within the top layer and the bottom layer of the sleeve; affixing together the top layer to the bottom layer in a lengthwise lateral area where the first lengthwise side of the sleeve was folded over to the second lengthwise side of the sleeve; affixing together the top layer to the bottom layer in across a width of the sleeve at a first sleeve end and at a second sleeve end, wherein the first sleeve end is spaced apart from the first sensor end of the sensor, wherein the second sleeve end is spaced apart from a second sensor end of the sensor, and wherein the sensor is movable within the sleeve; and cutting the first sleeve end and the second sleeve end to define a security tag.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of an example architecture for a system according to some present aspects;

FIG. 2 is a top view, with an outer sleeve removed and represented by a dashed line, of an example architecture for a security tag according to some present aspects;

FIG. 3 is an exploded perspective view of the architecture of FIG. 2, according to some present aspects;

FIG. 4 is a top view, with an outer sleeve removed and represented by a dashed line, of an alternative architecture for a security tag according to some present aspects;

FIG. 5 is an isometric view of a security tag having a sleeve attached at a weld line, according to some present aspects;

FIG. 6 is a top view of another example security tag, similar to security tag of FIG. 2, with the sensor portion of the tag contained within a sleeve and thus illustrated with dashed lines according to some present aspects;

FIG. 7 is a front exploded perspective view of the another example security tag, similar to security tag of FIG. 2, with the sensor shown exploded from the other components of the tag, according to some present aspects;

FIG. 8 is a top view of the security tag of FIG. 7 according to some present aspects;

FIG. 9 is a side view of the security tag of FIG. 7 according to some present aspects;

FIG. 10 is a top view of a process of separating a roll of sleeves and sensors into a plurality of security tags similar to the security tag of FIG. 7 according to some present aspects;

FIG. 11 is another top view of the roll of sleeves and sensors that can be separated into a plurality of security tags, similar to FIG. 10, but including details of rounded ends formed by a sleeve cutter at a separation line between tags according to some present aspects;

FIG. 12A is a detailed view of the area around separation line in FIG. 11, with a portion of the top layer of the sleeve removed exposing the sensor according to some present aspects;

FIG. 12B is an enlarged top view of a portion of the end of the security tag, as identified in FIG. 12A, including a sonically-welded portion;

FIG. 13 is an enlarged cross-sectional view along line 13-13 of FIG. 11;

FIG. 14 is a front view of object, e.g., a shirt, having a security tag as described herein attached within a seam via an attachment mechanism, e.g., stitching, as illustrated by the enlarged inset view 15-15;

FIG. 15 is a front view of a portion of the garment, tag, and attachment mechanism based on the inset view 15-15 of FIG. 14;

FIG. 16 is a schematic diagram of an example of a process by which plurality of security tags with tear-away features are separated, wherein a top layer of a sleeve of each tag is partially removed to expose a sensor inlay for illustration purposes, according to some present aspects;

FIG. 17 is a perspective view of an example of a security tag dispenser according to some present aspects; and

FIG. 18 is an exploded perspective view of the security tag dispenser of FIG. 17;

FIG. 19 is a bottom left partial perspective view of the security tag dispenser of FIG. 17, illustrating the plurality of connected security tags having tear-away features being fed through the housing of the gripper assembly between a gripping surface on the inside of the top wall of the housing and a guide member;

FIG. 20 is a bottom perspective vertical cross-sectional view of the security tag dispenser of FIG. 17, illustrating the plurality of connected security tags having tear-away features being fed through the housing of the gripper assembly between a gripping surface on the inside of the top wall of the housing and a guide member;

FIG. 21 is a top perspective horizontal cross-sectional view of the security tag dispenser of FIG. 17, illustrating the plurality of connected security tags having tear-away features being fed through the housing of the gripper assembly between a gripping surface on the inside of the top wall of the housing and a guide member;

FIG. 22 is another top perspective horizontal cross-sectional view of the security tag dispenser of FIG. 17, illustrating the plurality of connected security tags having tear-away features being fed through the housing of the gripper assembly, above the guide member but with the cross-section being below the gripping surface on the inside of the top wall of the housing; and

FIG. 23 is a flowchart of an example of an automated security tag manufacturing and encoding process.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Aspects of the present disclosure provide a security tag, such as a passive radio frequency identification (RFID) tag, which is designed to be physically capable of withstanding tensile, compressive, and/or abrasive forces which occur while positioning and/or affixing the security tag into an item, or while an item is in use, yet is sufficiently flexible and/or soft so as to not be noticeable to a person wearing the item.

For example, in an aspect, the security tag is configured to be movable within an outer sleeve, which may improve durability of the security tag. For instance, enabling movement of the security tag within the sleeve enclosing or encasing the security tag may help to avoid damage to the security tag due to bending of the tag, sleeve, and/or the item to which the tag or sleeve is applied, as the bending or flexing forces applied to the tag, sleeve, or item may be reduced or eliminated from being applied and/or transferred to the security tag by freeing the security tag from being constrained by the sleeve. As such, in this aspect, the security tag may referred to as a free-floating tag (or sensor).

Additionally, in another alternative or additional aspect, the security tag includes a sleeve having a flexible seal at one or both longitudinal ends for improved flexibility. The flexible seal may provide a softer feel to the ends of the security tag, as perceived by a user wearing an item, e.g., an article of clothing, to which the security tag is attached.

Turning now to the figures, example aspects are depicted with reference to one or more components described herein, where components in dashed lines may be optional.

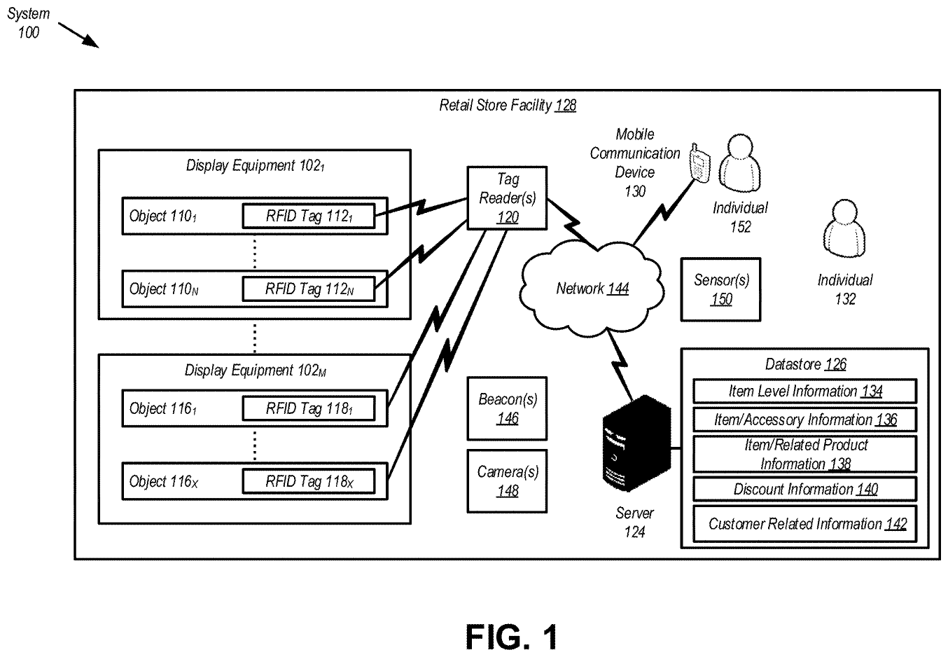

Referring now to FIG. 1, there is provided a schematic illustration of an example system 100 that is useful for understanding the present aspects. The present aspects are described herein in relation to a retail store environment. The present aspects are not limited in this regard and can be used in other environments. For example, the present aspects can be used in distribution centers, factories, and other commercial environments. Notably, the present aspects can be employed in any environment in which objects and/or items need to be located and/or tracked.

The system 100 is generally configured to allow: (a) improved inventory counts and surveillance of objects and/or items located within a facility, and/or (b) improved customer experiences. As shown in FIG. 1, in one example implementation, system 100 comprises a Retail Store Facility (“RSF”) 128 in which display equipment 102₁-102_{M} are disposed. The display equipment are provided for displaying objects (or items) 110₁-110_{N}, 116₁-116_{X} to customers of the RSF 128. The display equipment may include, but are not limited to, shelves, article display cabinets, promotional displays, fixtures, and/or equipment securing areas of the RSF 128. The objects (or items) 110₁-110_{N}, 116₁-116_{X} can include any type of product, such as but not limited to garments, clothing, shoes, electronics, boxed items, and/or any type of merchandise or good. The RSF 128 can also include emergency equipment (not shown), checkout counters, video cameras, people counters, and conventional electronic article surveillance (EAS) systems well known in the art, and therefore will not be described herein.

At least one tag reader 120 is provided to assist in counting and tracking locations of the objects 110₁-110_{N}, 116₁-116_{X} within the RSF 128, and/or to perform a checkout process associated with a user purchasing a respective object. The tag reader 120 may comprise an RFID reader configured to read RFID tags. Such a tag read may include the tag reader 120 receiving an identifier (e.g., a unique identifier) of a respective RFID tag 112, which may be associated with an identifier of the object 110 to which the RFID tag 112 is attached.

RFID tags 112₁-112_{N}, 118₁-118_{X} are respectively attached to the objects 110₁-110_{N}, 116₁-116_{X} as described below. This attachment may be achieved by a structural configuration of the RFID tag to enable the attachment. The RFID tags 112₁-112_{N}, 118₁-118_{X} can alternatively or additionally comprise dual-technology tags that have both EAS and RFID capabilities as described herein. In examples of the technology disclosed herein, the RFID tag is sewn or otherwise affixed into an object 110, for example into an interface between layers of the fabric/cloth of the object 110, which may be clothing or which may be another retail item.

Notably, the tag reader 120 may be placed at a known location within the RSF 128, for example, at an exit/entrance. By correlating the RFID tag reads of the tag reader 120 and the known location of the tag reader 120 within the RSF 128, the general location of objects 110₁, . . . , 110_{N}, 116₁, . . . , 116_{X} may be determined within the RSF 128. The known coverage area of the tag reader 120 also facilitates object location determinations. Accordingly, RFID tag read information and tag reader location information is stored in a datastore 126. This information may be stored in the datastore 126 using a server 124 and a network 144 (e.g., an Intranet and/or Internet). Additionally, the tag reader 120 or another computer device, such as but not limited to a point of sale terminal, may read a respective RFID tag 112 during a check-out or payment process and confirm that the object 110 to which the RFID tag 112 is attached is the object being paid for in the check-out or point of sale transaction.

System 100 may also comprise a Mobile Communication Device (“MCD”) 130. MCD 130 includes, but is not limited to, a cell phone, a smart phone, a table computer, a personal digital assistant, and/or a wearable device (e.g., a smart watch). In accordance with some examples, the MCD 130 has a software application installed thereon that is operative to facilitate the provision of various information (e.g., 134, 136, 138, 140, and/or 142) to the individual 152 and/or to facilitate the sale or purchase transaction.

The MCD 130 may generally be configured to provide a visual and/or auditory output of item level information 134, accessory information 136, related product information 138, discount information 140, and/or customer related information 142.

The MCD 130 may also be configured to read barcodes and/or the RFID tag 112. Information obtained from the barcode and/or RFID tag reads may be communicated from the MCD 130 to the server 124 via network 144. Similarly, the stored information (e.g., 134, 136, 138, 140, and/or 142) may be provided from the server 124 to the MCD 130 via the network 144. The network 144 may include an Intranet and/or the Internet.

Server 124 may be local to the RSF 128 as shown in FIG. 1 or remote from the RSF 128. It should be understood that server 124 may be configured to: write data to and read data from datastore 126, RFID tags 112₁-112_{N}, 118₁-118_{X}, and/or MCD 130; perform language and currency conversion operations using item level information 134 and/or accessory information 136 obtained from the datastore 126, RFID tags 112₁-112_{N}, 118₁-118_{X}, and/or MCD 130; perform data analytics based on inventory information (e.g., 134, 136, 138, 140, and/or 142), tag read information, MCD tacking information, and/or information 134-142; perform image processing using images captured by camera(s) 148; and/or determine locations of RFID tags 112₁-112_{N}, 118₁-118_{X} and/or MCDs 130 in the RSF 128 using beacon(s) 146, tag reader 120, or other devices having known locations and/or antenna patterns.

In some examples, one or more beacons 146 transmitting a radio frequency (RF) signal (e.g., a second RF signal) other than the RFID interrogation signal are placed to cover a zone of interest (which in some cases may be also covered by a tag reader 120 placed to cover an RFID interrogation zone), e.g., at a portal (such as an entrance or exit) of the RSF 128.

The server 124 may update the information (e.g., 134, 136, 138, 140, and/or 142) output from the MCD 130 and/or the tag reader 120 and/or any other terminal and/or point of sale device that interacts with the RFID tag 112. Such information updating may be performed in response to instructions received from an associate (e.g., a retail store employee 132), in response to a detected change in the item level information 134, accessory information 136, and/or related product information 138, in response to a detection that an individual is in proximity to an RFID tag, and/or in response to any motion or movement of the RFID tag. For example, if a certain product is placed on sale, then the sale price for that product may be transmitted to MCD 130 via network 144 and/or RFID tag 112/118. The sale price may then be output from the MCD 130. It should be noted that the present aspects are not limited to the particulars of this example.

Although a single MCD 130 and/or a single server 124 is (are) shown in FIG. 1, the present aspects are not limited in this regard. More than one computing device may be implemented. In addition, the present aspects are not limited to the example system architecture described in relation to FIG. 1.

In some aspects, during operation of system 100, the content displayed on the display screen of the MCD 130 may be dynamically controlled based upon various tag or item related information and/or customer related information (e.g., mobile device identifier, mobile device location in RSF 128, and/or customer loyalty level). Tag or item level information 134 may include, but is not limited to, one or more of first information indicating that an RFID tag 112/118 is in motion or that an object is being handled by an individual 152, second information indicating a current location of the RFID tag 112/118 and/or the MCD 130, third information indicating an accessory or related product of the object to which the moving RFID tag is coupled, and/or fourth information indicating the relative locations of the accessory and the moving RFID tag 112/118 and/or the relative locations of the related product and the moving RFID tag 112/118. The first, second, and fourth information may be derived based on sensor data generated by one or more sensors 150 local to the RFID tag. In other words, in some cases, the RFID tags 112₁-112_{N}, 118₁-118_{X} may include one or more sensors 150 to detect their current locations, detect any individual in proximity thereto, and/or detect any motion or movement thereof. The sensors 150 may include, but are not limited to, an Inertial Measurement Unit (“IMU”), a vibration sensor, a light sensor, an accelerometer, a gyroscope, a proximity sensor, a microphone, and/or a beacon communication device. The third information may be stored local to the RFID tag(s) or in a remote datastore 126 as information 136, 138.

In those or other scenarios, a sensor embedded in the RFID tag 112/118 may detect when an individual 152 is handling the object in which the RFID tag 112/118 is inserted. When such a detection is made, the RFID tag 112/118 may retrieve the object's unique identifier from its local memory, and wirelessly communicates the same to the tag reader 120. The tag reader 120 may then pass the information to the server 124. The server 124 may use the object's unique identifier and the item/accessory relationship information (e.g., table) 136 to determine if there are any accessories associated therewith. If no accessories exist for the object, the server 124 may use the item level information 134 to determine one or more characteristics of the object. For example, the object may comprise a product of a specific brand. The server 124 may then use the item/related product information (e.g., table) 138 to identify: other products of the same type with the same characteristics; and/or other products that are typically used in conjunction with the object. Related product information for the identified related products may then be retrieved and provided to the MCD 130. The MCD 130 may output the related product information in a visual format and/or an auditory format. The individual 152 may perform user-software interactions with the MCD 130 to obtain further information related to the product of interest. The present solution is not limited to the particulars of this scenario.

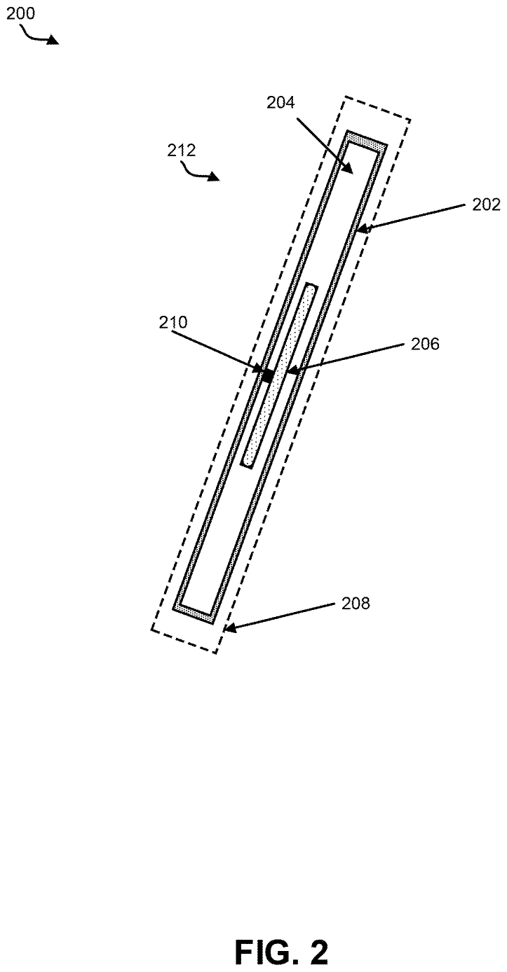

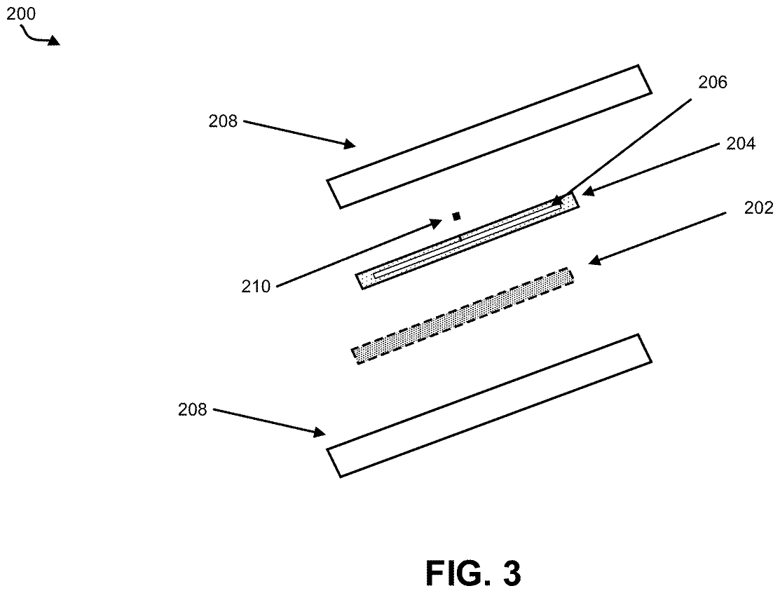

Referring to FIGS. 2-5, an example architecture for a security tag 200 is shown. RFID tags 112₁-112_{N}, 118₁-118_{X} are the same as or similar to security tag 200. As such, the discussion of security tag 200 is sufficient for understanding the RFID tags 112₁-112_{N}, 118₁-118_{X} of FIG. 1. In some implementations, security tag 200 may be configured to perform operations such as but not limited to: (a) minimize power usage so as to extend a power source's life (e.g., a battery or a capacitor), (b) minimize collisions with other tags so that the tag of interest can be seen at given times, and/or (c) optimize useful information within an inventory system (e.g., communicate useful change information to a tag reader)

Notably, the security tag 200 may be designed to be relatively thin and relatively flexible so that it is hard to feel when inserted into an item (e.g., object 110₁, . . . , 110_{N}, 116₁, . . . , or 116_{X} of FIG. 1). The object may include, but is not limited to, an article of clothing. In an aspect, the security tag 200 is configured to be movable within an outer sleeve, which may improve durability of the security tag 200, for instance, to avoid damage to the security tag 200 due to bending of the tag or the item to which the tag is applied. As such, in this aspect, the security tag 200 may referred to as a free-floating tag (or sensor). In an alternative or additional aspect, the security tag 200 includes an inlay having a plurality of openings along all or portion of a length of the inlay, which may improve durability of the security tag 200, for instance, to avoid damage to the security tag 200 due to bending of the tag or the item to which the tag is applied. In an alternative or additional aspect, the security tag 200 includes a sleeve having flexible seal at one or both longitudinal ends, which may provide a softer feel to the ends of the security tag 200, as perceived by a user wearing an item, e.g., an article of clothing, to which the security tag 200 is attached. Also, in a further alternative or additional aspect, the security tag includes a reinforcement layer to provide support to the antenna and RFID chip, thereby reducing bending forces applied to the antenna and RFID chip.

Security tag 200 may include, for example, a semiconductor integrated circuit 210, e.g., an RFID chip, which provides the RFID-based functionality described above, electrically connected to a tunable antenna 204 that enables the circuit 210 to receive and/or transmit signals, and that may be mounted on an inlay 202. In an aspect, the semiconductor integrated circuit 210, tunable antenna 204, and inlay 202 are contained within a sleeve 208. For example, the sleeve 208 may be formed by opposing material layers, which may be separate layers affixed at the ends and sides, or a single layer of material folded over and fixed together at the ends and the one open longitudinal side. As noted, a longitudinal length of the sleeve 208 may be greater than the longitudinal length of the combined semiconductor integrated circuit 210, tunable antenna 204, and inlay 202, which collectively may be referred to as the sensor 212, such that the sensor 212 may be movable within the sleeve 208.

The tunable antenna 204 may include a gap, straddled by the RFID chip, that opens to a loop portion 206. The tunable antenna 204 may be tuned to a desired operating frequency by adjusting the length of the tunable antenna 204. The range of operating frequencies may vary. In one aspect, for example, the tunable antenna 204 may be tuned to operate within an RFID operating frequency.

The inlay 202 to which the semiconductor integrated circuit 210 and the tunable antenna 204 are attached may be a relatively thin, narrow, light-weight substrate. In one aspect, the inlay 202 may be an elongated inlay 202 having a length substantially equal to or slightly greater than a length of the tunable antenna 204. In other words, the longitudinal length of the elongated inlay 202 and the longitudinal length of the tunable antenna 204 may be substantially equal.

The inlay 202 may include, but is not limited to, any type of plastic material, woven or non-woven fabric material, a biodegradable material, or other type of film material. In some aspects, the fabric material may be a cold water soluble nonwoven material manufactured from partially hydrolyzed polyvinyl alcohol fibers (a PVA fabric). In an aspect, the PVA fabric may substantially retain water until the water soluble material of the inlay 202 disintegrates during a wash cycle. In an aspect, the biodegradable material may be a biodegradable paper material or another hydrophilic material. A thickness of the inlay 202 may be selected so that the inlay 202 has a physical strength that allows a threshold amount of tension and/or compression to be maintained on the security tag 200 while attaching the tag to an object 110/116. For example, but not limited hereto, the thickness can have a value between approximately 10 um and approximately 200 um. Further, for example but not limited hereto, a width of the inlay 202 may be between approximately 2.5 mm and approximately 5 mm, which is small enough so that the security tag 200 is not felt by humans when inserted into an item worn by the human. It should be understood that the present solution is not limited to the particulars of this example.

In some aspects, the inlay 202 may comprise a polyester (e.g., PET) substrate.

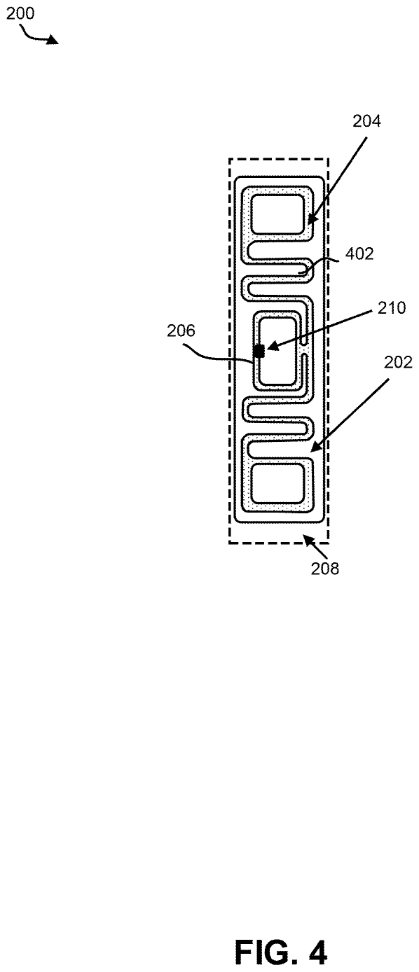

In some aspects, at least a portion of the tunable antenna 204 of the security tag 200 may be formed as one or more conductive trace(s) (also see conductive traces 402 of FIG. 4) via etching. The conductive trace/layer may be, but is not limited to, aluminum or some other electrically and/or magnetically conductive material.

Generally speaking, the resonance characteristics and tuning (and tunability) of the tunable antenna 204 may be determined not only by the antenna geometric shape and dimensions, material layering and construction, and fabrication materials, but also by the characteristics of the environment surrounding the antenna. Types of antennas that may be used in the security tag 200 may include dipole antennas, patch antennas, slot antennas, and many other types and variations of these types. In an aspect, the tunable antenna 204 may be designed so that the operating frequency of the security tag 200 is an ultra-high frequency (UHF).

The tunable antenna 204 may be configured to electrically couple with the circuit 210, such as but not limited to via inductance. The tunable antenna 204 may longitudinally extend across substantially the entire length of the security tag 200, although, preferably, the length of the antenna is less than a length of the security tag 200 to allow the. The tunable antenna 204 may be fabricated by positioning a water-soluble conducting ink on the inlay 202. Materials used for the conductive ink may include, but are not limited to, a metal particle, including but not limited to, silver, copper, graphene, a flux, a dispersing agent, an inorganic binder, a metal oxide, an organic metal compound, or a mixture of two or more thereof. However, in various implementations, the tunable antenna 204 may be made of conductive wire, like copper wire, steel wire, and the like.

In some aspects, but not limited hereto, the tunable antenna 204 may extend along the security tag 200 in a longitudinal direction and may have a diameter around 100 microns.

Additionally, as noted above, the security tag 200 may further include an elongated protective sleeve 208 which substantially encapsulates the inlay 202, the tunable antenna 204, the loop portion 206, and the circuit 210. In an aspect, the sleeve 208 forms a pocket within which the inlay 202, the tunable antenna 204, the loop portion 206, and the circuit 210 are movable, which may help reduce stress on the sensor during bending or stretching of the sleeve 208 or the item to which the sleeve 208 is attached. The protective sleeve 208 may be formed of a fabric or a plastic material, and may be a single sheet wrapped around the internal components and sealed or fixed together on one side, or two opposing sheets sealed or fixed together on each side. The protective sleeve 208 may comprise an ultrasonically weldable thermoplastic material, such as, but not limited to, nylon, combination of polyester and cotton, and the like. Although the protective sleeve 208 in this example is illustrated using dashed lines as a single layer, it should be understood that the protective sleeve 208 forms an outer layer including a top layer and a bottom layer. In one implementation, the elongated protective sleeve 208 includes a single textile sheet having a first longitudinal side fixedly attached to an opposite, second longitudinal side, and affixed at each longitudinal end.

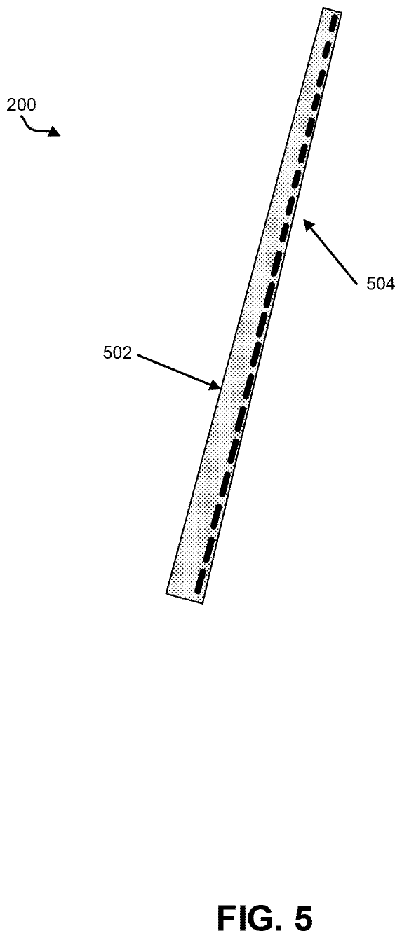

In the present aspects, the security tag 200 may be flexible, bendable, stretchable, or otherwise configured and/or constructed to sustain deformations. Further, for example but not limited hereto, a width of the security tag 200 may be between 3.5 mm and 6 mm, and a length of the security tag 200 may be between 80 mm and 145 mm which is small enough so that the tag is not felt by humans when inserted into an item. The present aspects are not limited to the particulars of this example. Also, the flexibility of the security tag 200 allows for the security tag 200 to be constructed and arranged so that the aforementioned deformations do not negatively affect the functionality and operation of the electronic components disposed within the security tag 200. In some aspects, electronic components are positioned on one side off a center of the security tag 200, so that a stitching lane (see, e.g., FIG. 5) may be created for secure attachment of the security tag 200 to an article of clothing. In some aspects, the security tag 200 may be manufactured to satisfy standards of environmental sustainability. For example, in some aspects, a natural-fiber fabric, recycled materials, or bio-based materials may be used as the inlay 202 (or as a portion of the inlay 202) so that the security tag 200 incorporates less plastic material than conventional security tags. Recycled materials may include, but are not limited to, recycled polyester or recycled paper, and bio-materials may include, but are not limited to, biopolymers or paper.

Referring specifically to FIG. 4, an example of an alternative architecture for the security tag 200 is provided. In this example architecture, the integrated circuit 210 and the loop portion 206 may be incorporated into the design of the tunable antenna 204. In an aspect, the tunable antenna 204 may include a rectangular loop antenna, which is inherently differential.

The inlay 202 material may include, but is not limited to, standard paper or water dissolvable paper. It should be noted that portions of the paper which are not completely dissolved during a wash cycle may remain inside the protective sleeve 208.

In summary, the security tag 200 may be produced by combining different material and/or component layers, such as the tunable antenna 204 attached to the inlay 202, the intermediate layer including a semiconductor integrated circuit 210 electrically coupled with a loop portion 206, such as via inductive coupling, and the outer layer including an elongated protective sleeve 208, such as formed from a fabric, that covers the semiconductor integrated circuit 210, the tunable antenna 204, and the inlay 202. Advantageously, the tunable antenna 204 is designed to be very narrow as compared to typical RFID antennas.

It should be understood, however, that the various layers may be manufactured and/or assembled in a different manner and/or in a different order and/or by different entities (e.g., antenna manufacturer, tag manufacturer, tag converter entities).

Thus, the methods and structures herein provide a flexible, fabric-like, narrow security tag 200 that can be easily and efficiently attached (sewn) into a space between seams that connect two adjacent layers of material of an article of clothing. The two layers of the article of clothing may be stitched together by overlock stitches. However, in various aspects, the security tag 200 may be sewn, glued, or welded onto any other portion of an article of clothing.

Referring specifically to FIG. 5, a completed welded security tag, such a security tag 200, includes the electronic components being positioned on one side 502 off a center of the security tag 200, so that a continuous stitching lane 504 may be created for secure attachment of the security tag 200 to an article of clothing. In other words, since the electronic components are situated on one side of the security tag 200, they are less likely to be damaged by sewing needles when the security tag 200 is attached to an article of clothing, and/or by sewing or welding of the opposing longitudinal edges of the material of sleeve 208, e.g., when a single layer of material is folded over to form the sleeve 208.

The disclosed aspects provide a soft, easy to attach, discreet, high-performing, durable, and economical RFID security tag having one or more water soluble components. In an aspect, such a tag can be attached to an overlock seam of the article. For example, some disclosed aspects replace a majority of a PET inlay with a water soluble inlay having a conductive ink antenna in the core of a fabric sleeve. Advantageously, the disclosed aspects enable tagging of thin, lightweight, one-ply garments, which are difficult to tag with any existing tagging solutions. As yet another advantage, the disclosed tag can be easily disabled during a first wash cycle of the garment.

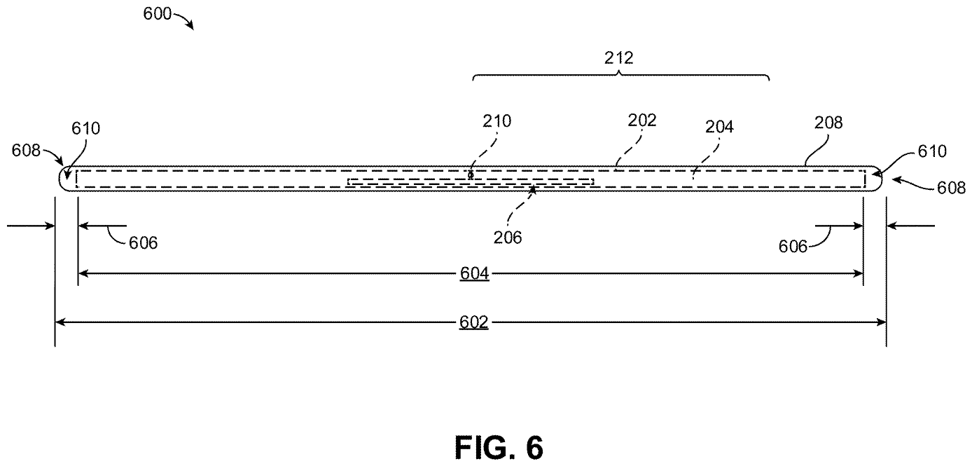

Referring to FIGS. 6-16, additional aspects of a security tag similar to the security tag of FIGS. 2-5 include one or more features, which can be combined in any way, which improve the ability of the security tag to withstand bending or other forces. Thus, a security tag including one of more of the features of FIGS. 6-16 enables the sensor portion of the security tag to maintain operational performance despite being subjected to such forces.

Referring to FIG. 6, in an aspect, an example security tag 600 is configured to have sensor 212 (e.g., semiconductor integrated circuit 210, tunable antenna 204, loop portion 206, and inlay 202) movable within the outer sleeve 208, which may improve durability of the security tag 600, for instance, to avoid damage to the security tag 600 due to bending of the tag or the item to which the tag is applied. For example, the sleeve 208 may have a longitudinal length 602 that is greater than a longitudinal length 604 of the sensor 212, thereby leaving distance 606 at each end 608 within which the sensor 212 may move. The distance 606 defines a free space 610 within the pocket or enclosure formed by the sleeve 208. In some aspects, the sensor 212 may move into all or some portion of the free space 610 when subjected to a force, such as a bending force, thereby moving independently from sleeve 208 and resulting in less stress to the sensor 212. In other aspects, the free space 610 can result in increased flexibility of the end portions of the security tag 600, as compared to a tag where the sensor extends all the way or nearly all the way to the ends, thereby softening a feel of each end 608 of the security tag 600. Further, the ends 608 may be curved, which also provides a softer feel to the ends relative to a security tag having flat ends.

In any case, due to the ability of the sensor 212 to move relative to the sleeve 208, the security tag 600 may referred to as a free-floating tag or free-floating sensor. In other words, the free-floating sensor 212 can move, e.g., “float,” within the sleeve 208 to allow more flexibility of the sensor 212 and reduce the effects of being stretched, bent, pulled, or twisted by the sleeve 208 to reduce damage caused by these actions, whether an item (e.g., garment) to which the security tag 600 is attached is washed, tried on or being handled. In one use case, for instance, the ‘floating’ aspect of the sensor 212 within the sleeve 208 “shifts” the sensor 212 within the sleeve 208, which greatly minimizes direct, constant, predictable contact of any one particular area of the sensor 212 with the harsh surfaces of the Industrial wash equipment. As a result, use of security tag 600 helps to produce near perfect final product yields, i.e., no breaks and/or tears to the coupling antenna and/or the inductive loop after washing, and/or product handling. Thus, in this aspect, the sensor 212 can move independently within the sleeve 208.

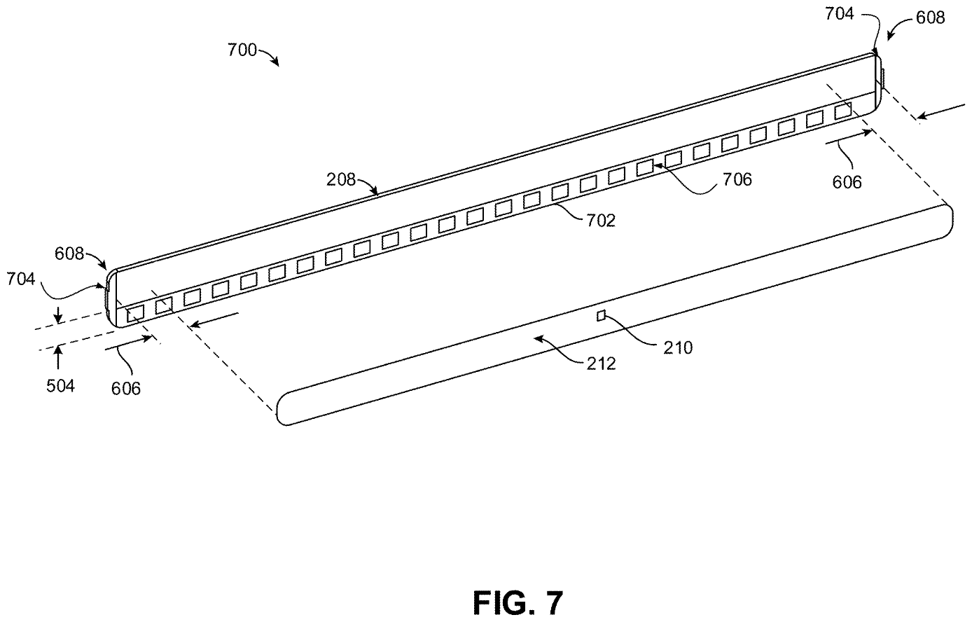

Referring to FIGS. 7-16, in an aspect, another example security tag 700, which is the same as or similar to security tag 200 and/or security tag 600, also enables the sensor 212 to move relative the sleeve 208 and additionally may include one or more features to soften the ends, enable efficient separation of two fixedly attached security tags, and/or improve the durability of the sensor 212.

In an aspect, referring more specifically to FIGS. 7-9, the opposing longitudinal ends 608 and the lengthwise edge 702 of the folded over material of the sleeve 208 are affixed via fixation mechanisms 704 and 706, respectively. In an aspect, fixation mechanisms 704 and 706 are sonic welds, but they can alternatively include sewn seams, adhesively connected seams, or any other type of connecting mechanism. As described above, the longitudinal center of sensor 212 is spaced-apart from the longitudinal center of the sleeve 208, e.g., away from lengthwise edge 702, which avoids interference and/or damage to the sensor 212 by fixation mechanism 706 that extends along one side of the length of the sleeve 208, e.g., within the stitching lane 504.

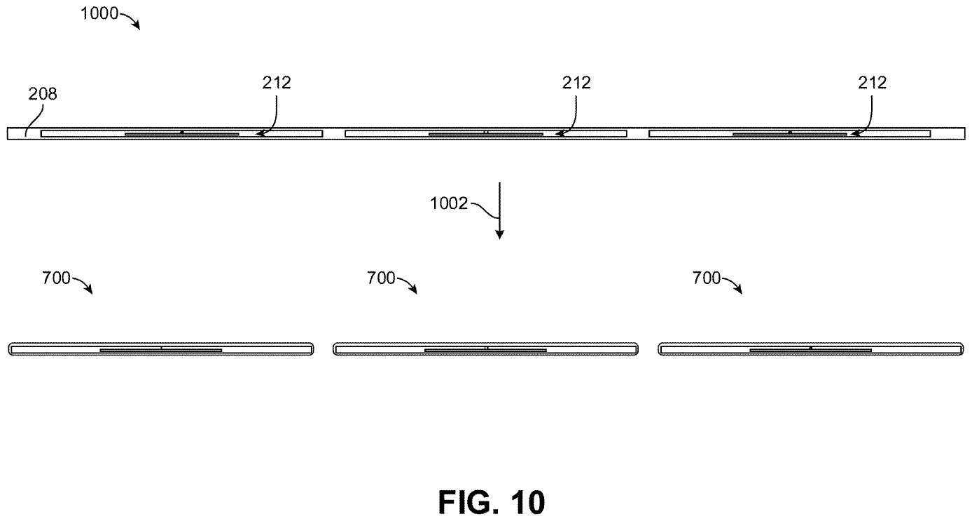

Referring specifically to FIG. 10, in an aspect, like the other security tags described herein, security tag 700 may be formed from a length 1000 of a plurality of sensors 212 within a length of the material of the sleeve 208 dispensed from a reel. In this example, a sonic welder and/or a cutting and/or dispensing machine executes a separation process, represented by arrow 1002, to form individual security tags 700 from a strip or string of a plurality of security tags 700 connected together at opposing, adjacent ends.

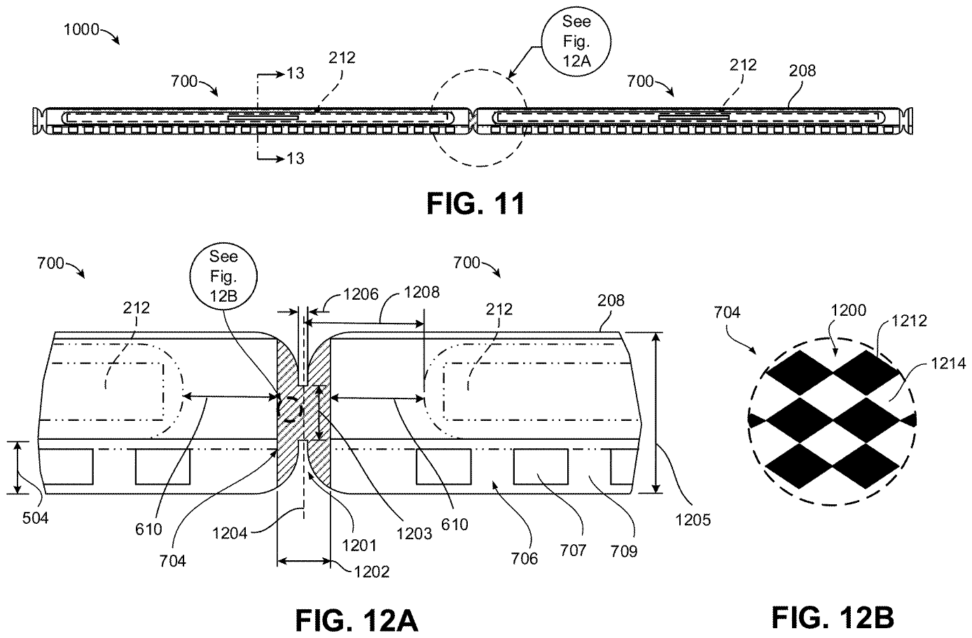

Referring specifically to FIGS. 11 and 12A, the opposing layers of the sleeve 208 of adjacent security tags 700 may be affixed across an end connection zone 1202, and then separated along separation line 1204. The separation process may include, but is not limited to, rounding the ends of the adjacent security tags 700 and forming a notch having a length 1206 on opposing ends of the separation line 1204, which may allow for slight variability in the separating process to make the separation along separation line 1204. Additionally, the separation line 1204 is located a spaced apart distance 1208 from an end of each respective sensor 212 so as to avoid damaging the respective sensors 212. Whether or not the opposing ends of the adjacent security tags 700 are rounded, a tab 1201 may be formed to connect the adjacent security tags in the end connection zone 1202. In an aspect, the tab 1201 has a lateral width 1203, e.g., a distance substantially perpendicular to a longitudinal axis the of the adjacent security tags 700, that is less than a lateral width 1205 of the adjacent security tags 700, which is configured to allow the adjacent security tags 700 to be torn apart from one another at the location of the tab 1201 or at least within the end connection zone 1202. Moreover, the end connection zone 1202 leaves free space 610 within the sleeve 208 for each sensor 212 to move.

Referring specifically to FIGS. 12A and 12B, the fixation mechanism 704 at the end connection zone 1202 may have a different fixation pattern 1200 or characteristic than the fixation mechanism 706 along the lengthwise edge (or side) 702. For instance, rather than having a relatively long, spaced apart pattern of inverted fixation areas 707, 709 (e.g., ultrasonically welded together) like fixation mechanism 706, the fixation pattern 1200 of the fixation mechanism 704 may include a plurality of relatively smaller adjacent inverted fixation areas 1212, 1214 (e.g., ultrasonically welded together) distributed across the end. Further, in some aspects, the plurality of relatively smaller fixation areas 1212 and/or 1214 may be spaced apart from one another. For example, the plurality of relatively smaller fixation areas 1212 may be spaced apart from and/or adjacent to a plurality of opposing fixation areas 1214. For example, the plurality of opposing areas 1214 may be affixed areas having a pattern that is opposite to, or inverted relative to, the plurality of relatively smaller fixation areas 1212. Alternatively, in an aspect, the plurality of opposing areas 1214 may be non-affixed areas that provide a spacing between the fixation areas 1212. For instance, in an implementation where the fixation mechanism 704 is a sonic weld, the fixation pattern 1200 may be a waffle-like pattern. The relatively smaller, inverted fixation pattern 1200 can improve the seal reliability at the ends of the security tag 700, and also provide improved touch and feel, e.g., a softer, more flexible end, due to the increase flexibility provided by the spacing and/or the configuration of opposing fixation areas 1212, 1214.

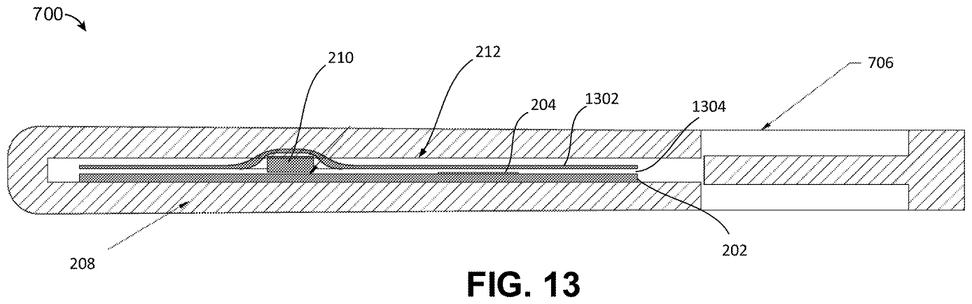

Additionally, referring specifically to FIG. 13, in some aspects, the sensor 212 may include an optional protective layer 1302 on a top surface, which can be affixed to the substrate via an optional adhesive layer 1304. The protective layer 1302 may be a plastic material, such as but not limited to a polyethylene terephthalate material, or any other type of material that may protect the sensor 212 from impacts, and optionally resist absorption of water or fluid that may damage the sensor 212. The adhesive layer 1304 may be any type of glue or binding compound or any other bonding material.

Thus, in these aspects, the security tag 700 includes flexible seals at one or both longitudinal ends, which may provide a softer feel to the ends of the security tag 700, as perceived by a user wearing an item, e.g., an article of clothing, to which the security tag 700 is attached.

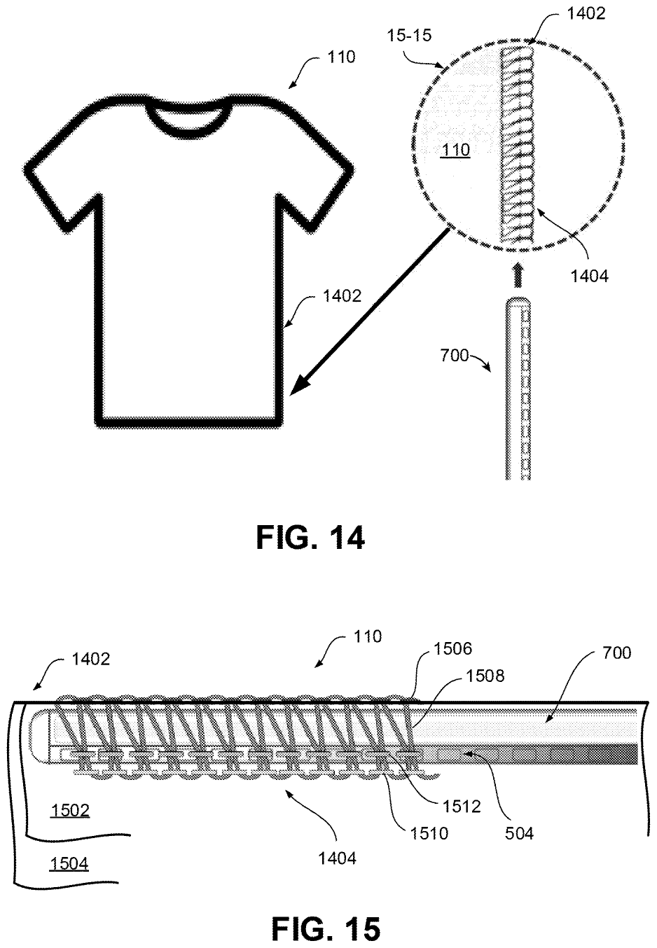

Referring to FIGS. 14 and 15, any of the security tags described herein, such as security tag 700 (and/or security tag 200 and/or 600), may be affixed to any type of object 110 via one or more types of fixation mechanisms. In this example, security tag 700 is affixed to object 110, e.g., a garment such as a shirt, at a seam 1402 formed by connected ends of two layers of material 1502 and 1504, via an attachment mechanism 1404. For instance, the two layers of material 1502 and 1504 may be a fabric material, although other types of materials may be used. In this case, attachment mechanism 1404 is a stitch formed by one or more threads, such as but not limited to an overlock stitch formed by a first looper thread 1506, a second looper thread 1508, a first straight thread 1510, and a second straight thread 1512. At least one of the threads, such as first straight thread 1510 in this case, can be sewn through the stitching lane 504 to affix the security tag 700 to the object 110. In some aspects, the security tag 700 may be located on an outside surface of the two layers of material 1502 and 1504, e.g., which may improve an ease of assembly of the security tag 700 onto the object 110. In other cases, the security tag 700 may be located in between the two layers of material 1502 and 1504, e.g., to hide or reduce visibility the security tag 700 and/or to reduce wear and tear on the security tag 700. It should be understood, however, that attachment mechanism 1404 may alternatively or additionally include other mechanisms, such as but not limited to an adhesive layer to affix together the security tag 700 and the object 110 (and/or the two layers of material 1502 and 1504), an ultrasonic welding of the security tag 700 and the object 110 (and/or the two layers of material 1502 and 1504). Thus, the security tag 700 can be unobtrusively attached to the object 110 via the attachment mechanism 1404.

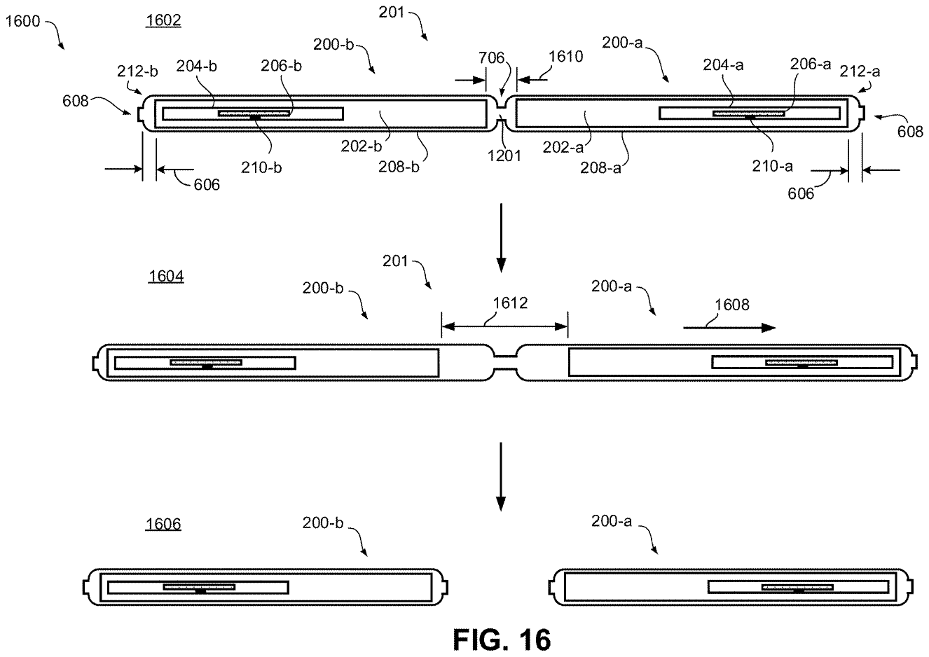

Referring to FIG. 16, an aspect of the present disclosure includes a process 1600 of separating a connected plurality of security tags 201 into separate, individual security tags. In this example, the plurality of security tags 201 include at least a first security tag 200-a and a second security tag 200-b connected together at adjacent longitudinal ends to form a strip or string configuration in a connected state 1602. Then, the process 1600 includes the security tags 200-a and 200-b being stretched apart in a separation process state 1604, and the resulting separated, individual tags in a separated state 1606. In FIG. 16, two security tags are shown to be connected together, however, more security tags may be connected together to form a longer strip or string of a plurality of security tags, according to various aspects of the present disclosure. It should be noted that each of the security tags 200-a, 200-b may be the same or similar to security tag 200 of FIGS. 2-5 (and, hence, the discussion herein utilizes “-a” or “-b” to after the reference number of a similar component), security tag 600 of FIG. 6, security tag 700 of FIGS. 7-9, and/or the adjacent security tags 700 of FIGS. 10-13.

In an aspect, in the connected state 1602, the first security tag 200-a is connected to the second security tag 200-b via a tab 1201 formed by and/or between adjacent fixation mechanisms 704 (also, see, e.g., FIGS. 7 to 12A) of sleeve 208, specifically sleeves 208-a, 208-b in this case, that respectively form the outer layer of the security tags 200-a, 200-b. In some aspects, first security tag 200-a and the second security tag 200-b may be connected by sewing, welding, gluing, or other suitable techniques, to form the tab 1201 and/or the fixation mechanism 704. The sleeves 208-a, 208-b may be made from a first material having a lower tensile strength than that of a second material associated with inlays 202-a, 202-b, which may be the same as or similar to inlay 202 (FIG. 2), respectively contained within each respective sleeve 208-a, 208-b. Here, the tensile strength may relate to the maximum tensile force a material can experience without tearing, shearing, or suffering other permanent structural damage.

In one example, the sleeves 208-a, 208-b may be made from one or any combination of polyethylene terephthalate (PET), polyamide (nylon), cotton, polypropylene, acrylonitrile butadiene styrene, polystyrene, polyethylene, cotton and a polymeric material, or other suitable materials having a first tensile strength in a first range. In some examples, the inlays 202-a, 202-b may be made from polyester, polyimide, glass fibre, polyamide, or other suitable materials having a second tensile strength in a second range, wherein the second tensile strength if greater than the first tensile strength. For instance, at least one or more values of the second range are greater than one or more values in the first range. In certain aspects, for example but not limited hereto, the materials for the sleeves 208-a, 208-b may be made from materials having tensile strengths in the range of 10-70 Mega Pascal (MPa), 20-60 MPa, or 30-50 MPa, while, correspondingly, the materials for the inlays 202-a, 202-b may be made from materials having tensile strengths in the range of 100-200 MPa, 120-180 MPa, or 140-160 MPa, etc. It should be noted that other tensile strengths for the sleeves 208-a, 208-b and/or the inlays 202-a, 202-b may be possible.

In certain aspects of the present disclosure, semiconductor integrated circuits 210-a, 210-b, tunable antennas 204-a, 204-b, and antenna loop portions 206-a, 206-b may be disposed on or within two or more layers the respective inlays 202-a, 202-b, which are respectively contained within the sleeves 208-a, 208-b. The longitudinal lengths of the semiconductor integrated circuits 210-a, 210-b, the tunable antennas 204-a, 204-b, and the loop portions 206-a, 206-b may be shorter than the longitudinal lengths of the inlays 202-a, 202-b, which may be shorter than the longitudinal lengths of the sleeves 208-a, 208-b, thereby leaving distance 606 at each end 608 within which the sensor 212 may move. As such, the semiconductor integrated circuits 210-a, 210-b, the tunable antennas 204-a, 204-b, and the loop portions 206-a, 206-b and the respective inlays 202-a, 202-b may be movable within the respective sleeves 208-a, 208-b.

In one aspect of the present disclosure, in the separation process state 1604, the security tags 200-a, 200-b may be pulled away from each other in order to separate the security tags 200-a, 200-b. For example, as a tensile force 1608 is applied to at least one of the security tags 200-a, 200-b (e.g., while the other security tag is being held), such as security tag 200-a, the sleeves 208-a, 208-b and/or the tab 1201 may stretch from their “normal” lengths 1610 (i.e., without experiencing tensile force, see connected state 1602) to longer lengths 1612. While the inlays 202-a, 202-b may experience a portion of the tensile force 1608 being applied, the inlays 202-a, 202-b may experience less extension than the sleeves 208-a, 208-b due to higher tensile strengths of the inlays 202-a, 202-b and/or because the inlays 202-a, 202-b are movable within the respective sleeves 208-a, 208-b. As shown in separation process state 1604, the sleeves 208-a, 208-b may stretch length-wise relative to the inlays 202-a, 202-b, which may remain substantially constant in their lengths.

In some aspects of the present disclosure, the semiconductor integrated circuits 210-a, 210-b, the tunable antennas 204-a, 204-b, and the loop portions 206-a, 206-b may be protected in the inlays 202-a, 202-b from the application of the tensile force 1608 due to the ability of the inlays 202-a, 202-b to move relative to, and independent of, the sleeves 208-a, 208-b. For example, the inlays 202-a, 202-b may stretch negligibly when the security tags 200-a, 200-b are being pulled apart. Consequently, the semiconductor integrated circuits 210-a, 210-b, the tunable antennas 204-a, 204-b, and/or the loop portions 206-a, 206-b may experience reduced, minimal, or zero tensile force. In other instances, the semiconductor integrated circuits 210-a, 210-b, the tunable antennas 204-a, 204-b, and the loop portions 206-a, 206-b may move freely along a longitudinal access of the sleeves 208-a, 208-b and thus experience minimal or zero tensile force. As such, the independent movement prevents the semiconductor integrated circuits 210-a, 210-b, the tunable antennas 204-a, 204-b, and the loop portions 206-a, 206-b from experiencing the tensile force 16081728 applied to the sleeves 208-a, 208-b.

In certain aspects of the present disclosure, as the tensile force 1608 is applied to the security tags 200-a, 200-b, a break may occur on the tab 1201, thereby resulting in the separated state 1606 wherein the security tags 200-a and 200-b are no longer connected. Here, the tensile force 1608 may be applied to the sleeves 208-a, 208-b and the tab 1201. However, the tab 1201 may be experience more tensile force because, in some aspects, the cross-sectional area of the tab 1201 is smaller than that of the sleeves 208-a, 208-b. As such, the tab 1201 may break under the application of the tensile force 1608 before other portions of the sleeves 208-a, 208-b, resulting in separating the security tags 200-a, 200-b into individual tags.

It should be understood that the tensile force 1608 may be applied to one of the security tags 200-a, 200-b while the other security tag is being held in place, or opposing tensile forces may be applied to each of the security tags 200-a, 200-b. In any case, the tensile force 1608 has a value or magnitude greater than a tensile strength of the tab 1201, thereby causing the tab 1201 to tear and thus separate the security tags 200-a and 200-b. For example, during a separation process operation, the first security tag 200-a and the second security tag 200-b may be pulled away from each other. For example, the first security tag 200-a may be pinned or held at a particular position while a user (not shown) or a machine pulls the second security tag 200-b from the first security tag 200-a. Since the tab 1201 is a “weak spot” between the sleeves 208-a, 208-b, the pulling by the user or machine may break off the second security tag 200-b from the first security tag 200-a. As such, the second security tag 200-b may be utilized in various applications, such as inserting into object 110, e.g., a textile material, or tagging onto a merchandise as described above.

In some aspects of the present disclosure, the first security tag 200-a and the second security tag 200-b may be pulled apart under 9-11 Newtons (N) of tensile force 1608, 7-13 N of tensile force 1608, or 5-15 N of tensile force 1608. Other amounts of tensile force 1608 are also possible depending on the material, size, and/or design of the tab 1201 and/or sleeves 208-a, 208-b.

In one aspect of the present disclosure, the security tags 200-a, 200-b may be among a plurality of security tags connected together in a strip or string and then rolled up and stored on a spool or reel, or in a roll (as described below. Consequently, as mentioned above, during a manufacturing operation, the security tags 200-a, 200-b may be respectively pulled from the spool, reel, or roll.

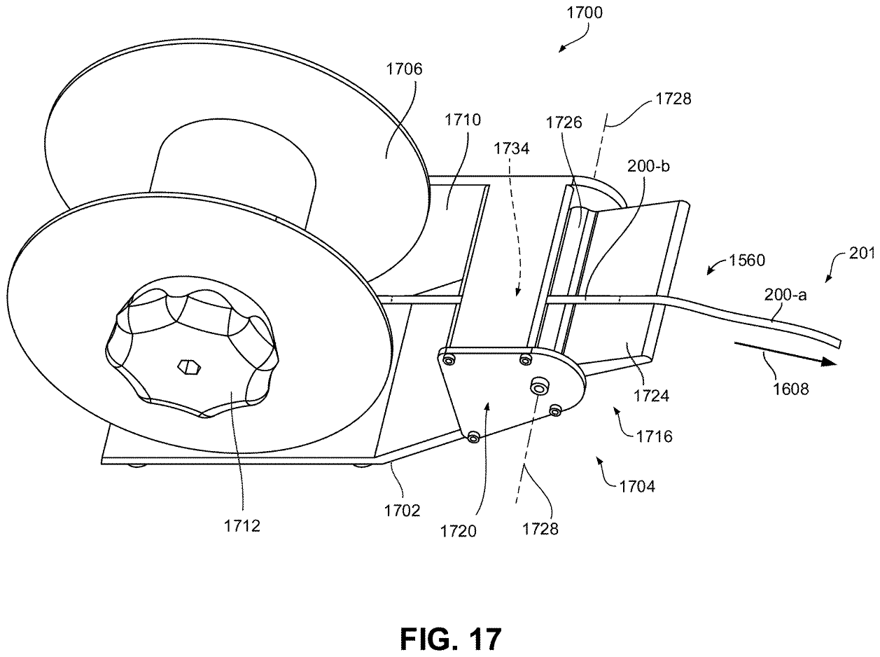

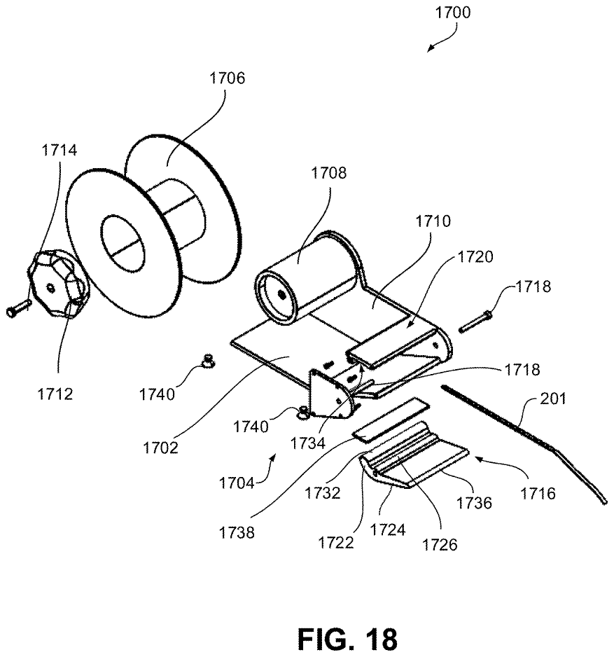

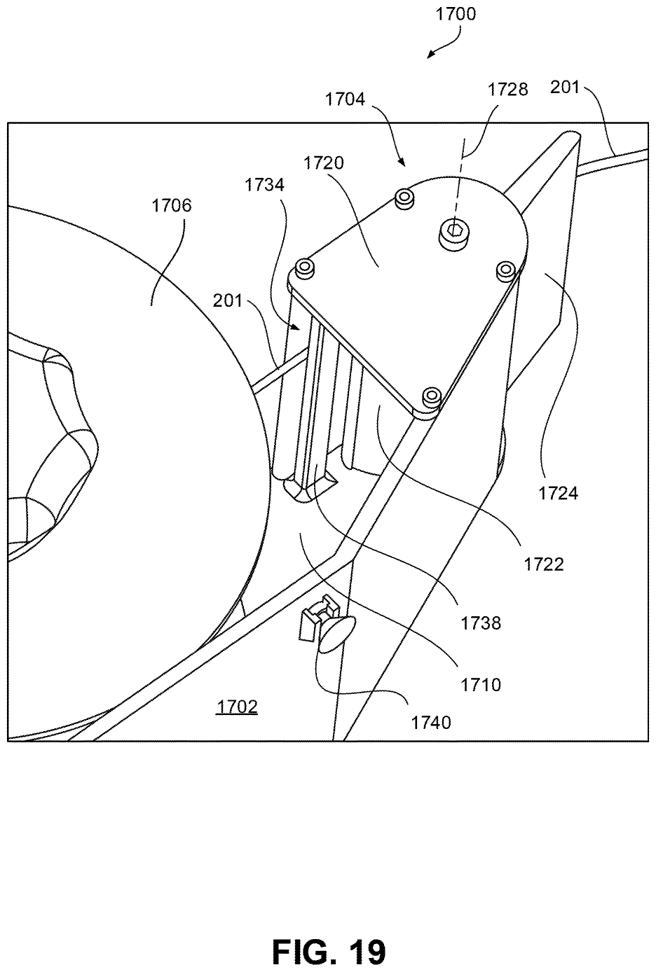

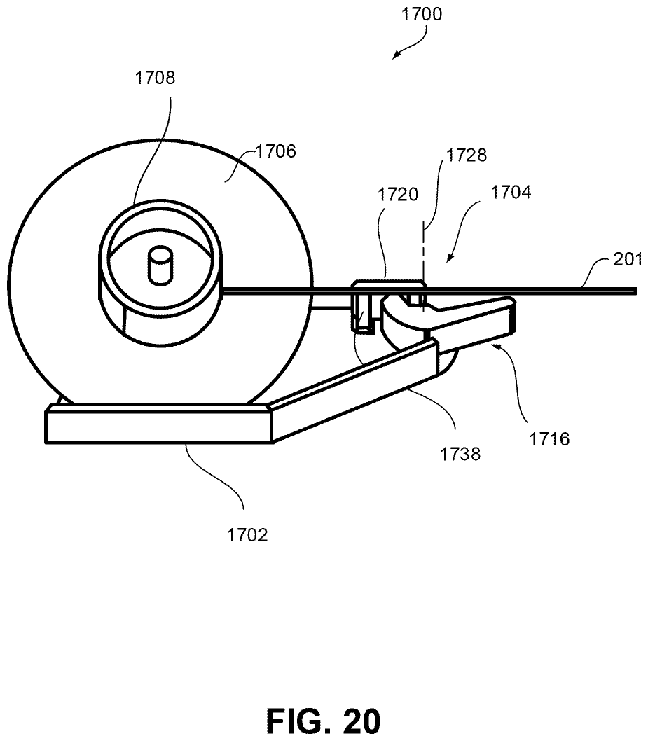

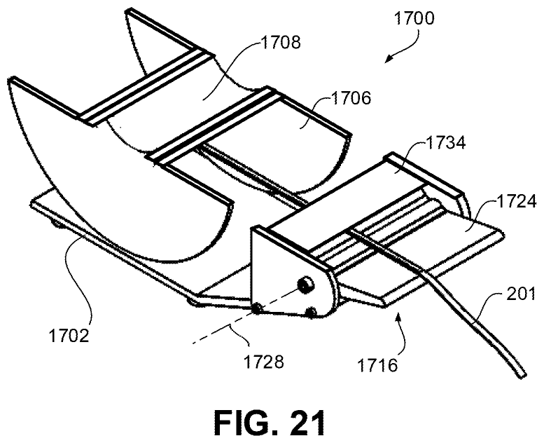

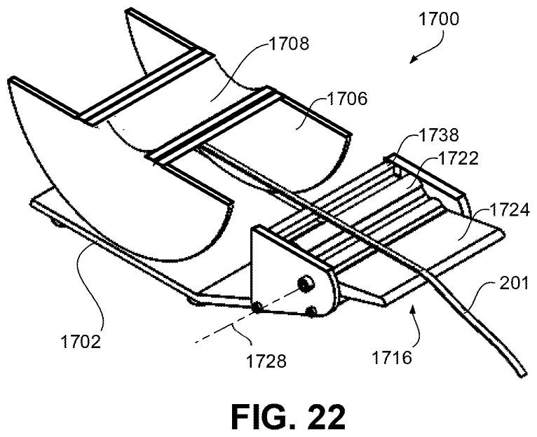

Referring to FIGS. 17-22, an example of a dispenser 1700 for dispensing a string of a plurality of connected security tags 201, including security tags 200-a and 200-b, includes a base 1702 having a gripper assembly 1704 configured to grip a second security tag, e.g., security tag 200-b, from a spool 1706 of the string of the plurality of connected security tags 201 to enable a first security tag, e.g., security tag 200-a, to be separated from the second security tag via application of tensile force 1608 (see, e.g., the separation process state 1604 describe above). The dispenser 1700 includes an axle 1708 (see FIG. 18) extending from a sidewall 1710 and configured to rotatably hold the spool 1706 of the string of the plurality of connected security tags 201 in place. The spool 1706 may be held onto the axle 1708 by a removable cap 1712, where a removable fixation mechanism 1714 (see FIG. 18), e.g., a screw or clip mechanism, is utilized for engagement with the axle 1708. The gripper assembly 1704 includes a pivot member 1716 rotatably mounted on an axle 1718 within a housing 1720. In an aspect, the axle 1718 may be a removable axle having a first axle portion removably connectable to a second axle portion, e.g., via opposing threaded members. The pivot member 1716 includes a gripping flange 1722 and a supporting flange 1724 extending from opposite sides of central axis portion 1726 rotatably connected with the axle 1718 and defining a pivot axis 1728. Upon application of the tensile force 1608, the pivot member 1716 rotates on axle 1718 and about axis 1728 such that a retaining end 1732 of the gripping flange 1722 rotatably holds the second security tag 200-b against a gripping surface 1734 of the housing 1720 while a lip 1736 at the end of the supporting flange 1724 is configured to provide an edge for separating the first security tag 200-a from the spool 1706 of the string of the plurality of connected security tags 201. Optionally, the gripping flange 1722 and/or the gripping surface 1734 may include a surface friction member configured to increase friction against the second security tag 200-b to help the hold the second security tag 200-b in place when the gripping flange 1722 is rotationally forced into the gripping surface 1734. For example, the surface friction member can be a relatively rough or knurled surface finish, and/or a layer of material (e.g., a rubber, an elastomer) having an increased coefficient of friction relative to the material of the gripping flange 1722 and/or the gripping surface 1734. Optionally, the dispenser 1700 may include a guide member 1738 to support and direct the plurality of connected security tags 201 to be in between the retaining end 1732 of the gripping flange 1722 and the gripping surface 1734 of the housing 1720. For example, the guide member 1738 may be a relatively flat, longitudinally extending member, or a rod-like member. Also, optionally, the dispenser 1700 may include a plurality of support legs 1740 for mounting the dispenser 1700 on a surface. For instance, the support legs 1740 may be rubber or elastomeric mounts, which may include concave ends that form suction cups, which are used to support the dispenser 1700 and/or prevent the dispenser 1700 from moving during application of tensile force 1608 as described herein. The components of the dispenser 1700 may be made of any type of plastic, metal, or composite material.

During operation, an operator (not shown) may pull on an end of the string of the plurality of security tags 201 that are fed through the gripper assembly 1704 from the spool 1706 and having a first security tag 200-a extending over the pivot member 1716. The gripper assembly 1704 is configured to grip a second security tag 200-b of the string of security tags 201 using friction force between the pivot member 1716 and the gripping surface 1734 of the housing 1720. For example, the operator may pull the first security tag 200-a (which may be the first security tag 200-a described above) of the string of security tags 201 in at least a partially downward direction relative to the lip 1736 at the end of the supporting flange 1724. The downward motion provides a tensile force 1608 on the first security tag 200-a relative to the second security tag 200-b (which may be the second security tag 200-b described above) of the string of security tags 201. Moreover, the at least partially downward direction of the tensile force 1608 at the lip 1736 at the end of the supporting flange 1724 causes the pivot member 1716 to rotate about pivot axis 1728, resulting in retaining end 1732 of the gripping flange 1722 to rotate into engagement with the second security tag 200-b and the gripping surface 1734 of the housing 1720. Consequently, the retaining end 1732 fixedly holds the second security tag 200-b against the gripping surface 1734, preventing the second security tag 200-b from being pulled out of the housing 1720 by the operator. Resultingly, the tensile force 1608 is applied to the sleeve of the first security tag 200-a in a sufficient amount to cause the first security tag 200-a to separate from the second security tag 200-b at the adjoining fixation mechanism 704, e.g., the tab 1201. The dispenser 1700 thereby allows the operator to obtain individual security tags from the string of security tags 201 using one hand.

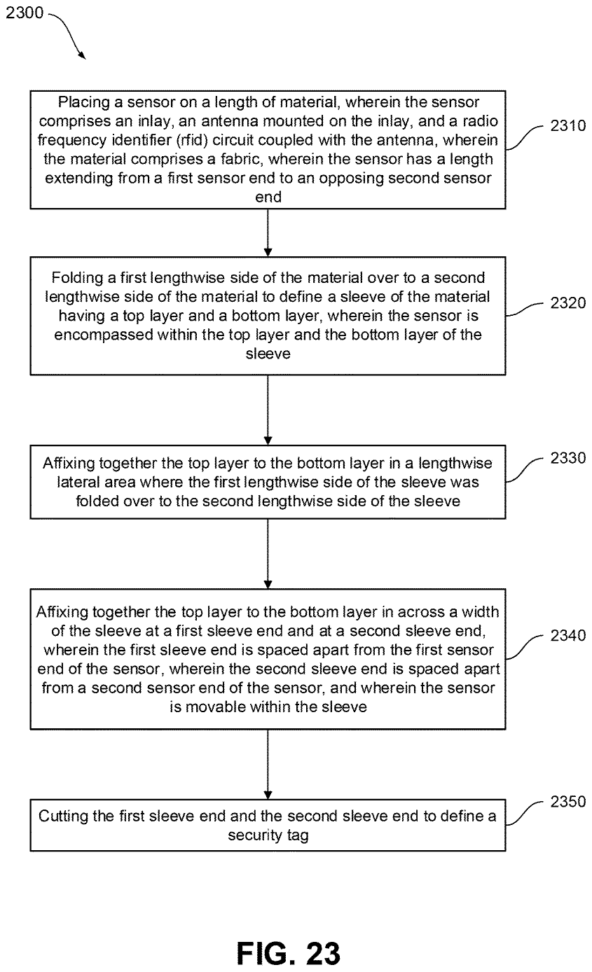

Referring to FIG. 23, in an alternative aspect, an automated process 2300 is configured for obtaining individual security tags 200. It should be understood that one or more of the following actions may be performed in a different order.

At block 2310, process 2300 includes placing a sensor on a length of material, wherein the sensor comprises an inlay, an antenna mounted on the inlay, and a radio frequency identifier (RFID) circuit coupled with the antenna, wherein the material comprises a fabric, wherein the sensor has a length extending from a first sensor end to an opposing second sensor end. For example, but not limited hereto, process 2300 may include a string of sensors 212 (e.g., a plurality of sensors 212 attached to a substrate) and a string of sleeves 208 (e.g., a flat length of sleeve material) that are fed together into a machine that places individual sensors 212 from the string of sensors in a spaced apart manner on the string of sleeves 208. In an aspect, the spaced apart sensors 212 are positioned close to one lengthwise side of the string of sleeves 208 so that at least half of the area of the string of sleeves 208 remains uncovered, e.g., free of sensors 212.

At block 2320, process 2300 includes folding a first lengthwise side of the material over to a second lengthwise side of the material to define a sleeve of the material having a top layer and a bottom layer, wherein the sensor is encompassed within the top layer and the bottom layer of the sleeve. For example, but not limited hereto, the string of sleeves 208 with the spaced apart sensors 212 is then fed into a sleeve material folder machine that folds the uncovered lengthwise area of the string of sleeves 208 over the opposing lengthwise area on which the spaced apart sensors 212 are located. For example, the sleeve material folder machine may include a curved guide member that moves the uncovered lengthwise area of the string of sleeves 208 over the opposing lengthwise area on which the spaced apart sensors 212 are located.

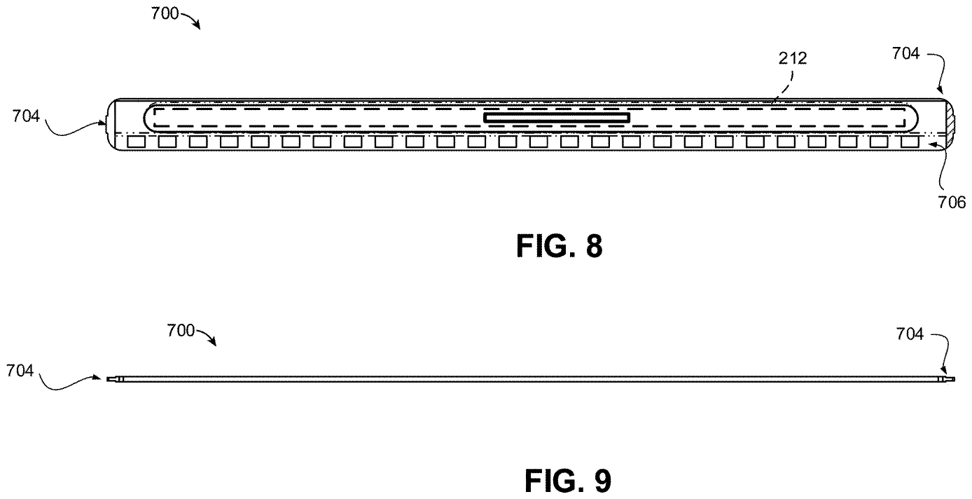

At block 2330, process 2300 includes affixing together the top layer to the bottom layer in a lengthwise lateral area where the first lengthwise side of the sleeve was folded over to the second lengthwise side of the sleeve. For example, but not limited hereto, the folded over string of sleeves 208 that contain the spaced apart sensors 212 are fed into an affixing machine, such as an ultra-sonic welding machine, that implements fixation mechanism 706 (see FIG. 8) to fixedly attach the folded over ends of the sleeve material to one another, e.g., defining stitching lane 504 (see, e.g., FIGS. 5, 7, and 12A).

At block 2340, process 2300 includes affixing together the top layer to the bottom layer in across a width of the sleeve at a first sleeve end and at a second sleeve end, wherein the first sleeve end is spaced apart from the first sensor end of the sensor, wherein the second sleeve end is spaced apart from a second sensor end of the sensor, and wherein the sensor is movable within the sleeve. For example, but not limited hereto, the folded over and partially affixed string of the material of the sleeve 208 with spaced apart sensors 212 is fed into an affixing machine that implements fixation mechanism 704 (see FIG. 8) to the portion of the string of sleeves 208 adjacent to opposing ends of adjacent sensors 212. For example, such affixing machine may be, for example, an ultrasonic welding machine. As a result, each spaced apart individual sensor 212 is now contained within a sleeve 208 sealed at each end and sealed along a lateral, lengthwise side, forming a string of a plurality of connected security tags 201. As noted, the plurality of connected security tags 201 are attached to one another by a tear-away feature, e.g., the fixation mechanism 704.

At block 2350, process 2300 includes cutting the first sleeve end and the second sleeve end to define a security tag. For example, but not limited hereto, the string of the material of the sleeve 208 with spaced apart sensors 212 within their own respectively sealed sleeve pocket is fed into a cutting machine configured to cut the laterally and the string of sleeves 208 that sealingly-contain separate spaced apart sensors 212 to cut them into individual security tags 200. In an aspect, the cutting machine includes a digital cutter or a die cutter, which can cut across the string of sleeves 208 at the separation line 1204 (see FIG. 12A) in the area of the fixation mechanism 704 that adjoins the adjacent, connected security tags. Moreover, in some aspects, the cutting machine can cut the ends of each security tag 200 to have curved edges (see, e.g., FIGS. 6 and 7) to avoid the ends having sharp corners, which may be felt by a person wearing a garment into which the security tag 200 may be placed.

Optionally, the process 2300 may additionally include each of the individual security tags 200 being carried past additional machines for performing additional operations on each security tag 200. It should be understand that the security tags 200 may be subject to any one of more of a plurality different additional manufacturing operations, which may be performed on each security tag 200 in any order.

In one implementation, for example, process 2300 includes encoding each security tag 200. For example, but not limited hereto, each security tag 200 may interact with an RFID encoding machine configured to encode additional information onto the semiconductor integrated circuit 210, e.g., the RFID chip. For instance, the additional information may include data relating to the manufacturing process 2300 (e.g., when manufactured, where manufactured, what materials are included in the security tag), and/or data relating to an object 110 (or 116) to which the security tag 200 is to be attached (e.g., type of garment/object, manufacturer information, size information).

Additionally or in the alternative, the process 2300 may include testing the antenna performance of each security tag 200. For example, but not limited hereto, each security tag 200 may interact with a sensitivity testing machine configured to test a signal transmission and/or signal reception performance of each security tag 200. For example, the sensitivity testing machine may include a transmitter, a receiver, and/or a transceiver configured to transmit and/or receive signals to communicate with each security tag 200. In one implementation, the sensitivity testing machine may include a transmitter or transceiver to transmit a command to each security tag 200 to transmit security tag identification information, and/or additional information as discussed above, to the sensitivity testing machine. Further, the sensitivity testing machine may include a receiver or transceiver to receive the requested security tag identification information, and/or additional information as discussed above, to the sensitivity testing machine. Further, the sensitivity testing machine may include a processor having an algorithm or a model to measure and report a signal response characteristic associated with each security tag 200 based on the received communications.

Also, in another alternative or additional aspect, process 2300 may include removing ones of the security tags 200 deemed to be defective. For example, but not limited hereto, a sorting machine may be in communication with one or more of the previously discussed components of process 2300 and may be configured to remove defective ones of the security tags 200 from being output by process 2300. For example, the sorting machine may be any type of device or mechanism capable of separating a defective security tag 200 from a non-defective security tag 200. In some cases, the sorting machine may be a mechanical arm, a directional conveyor belt, a vacuum machine, a directed flow of air, or any other mechanism configured to move a defective security tag 200 to a different output location relative to a non-defective security tag 200.

Further, in an alternative or additional aspect, process 2300 may include counting an output of the process. For example, but not limited hereto, a counter machine may be configured to identify and count each security tag 200 that is output by process 2300. For instance, the counter machine may be, but is not limited to, a system such as a vision system configured to identify a security tag, a magnetic system configured to detect a change in magnetic field caused by presence of a security tag, a wireless communication system configured to exchange communications with a security tag, or any other type of device capable of recognizing security tag 200 at an output of process 2300.

Thus, the present disclosure includes one or any combination of the following aspects.

Clause 1. A plurality of security tags, each of the plurality of security tags comprising: a sleeve having a first tensile strength; and an inlay having a second tensile strength, the inlay being disposed movably within the sleeve and including: an antenna mounted on the inlay; and a radio frequency identifier (RFID) circuit coupled with the antenna; and a first tab and a second tab each having a third tensile strength, wherein at least one of the first tab or the second tab is configured to detachably couple the security tag with an adjacent one of the plurality of security tags; wherein the first tensile strength is smaller than the second tensile strength and larger than the third tensile strength.

Clause 2. The plurality of security tags of clause 1, wherein a material of the sleeve includes one or more of polyethylene terephthalate, polyamide, cotton, polypropylene, acrylonitrile butadiene styrene, polystyrene, or polyethylene.

Clause 3. The plurality of security tags of any preceding clause, wherein the material has a tensile strength between 10 and 70 Mega Pascal (MPa).

Clause 4. The plurality of security tags of clause 1, wherein a material of the inlay includes one or more of polyester, polyimide, glass fiber, or polyamide.

Clause 5. The plurality of security tags of any preceding clause, wherein the material has a tensile strength between 100 and 120 Mega Pascal (MPa).

Clause 6. The plurality of security tags of any preceding clause, wherein a first material of the sleeve is a same material as a second material of the plurality of tabs.

Clause 7. The plurality of security tags of any preceding clause, wherein a first width of the plurality of tabs is narrower than a second width of the plurality of security tags.

Clause 8. The plurality of security tags of any preceding clause, wherein the third tensile strength between 9 and 11 Newtons (N).

Clause 9. The plurality of security tags of any preceding clause, wherein the plurality of tabs are configured to couple to the plurality of security tags by ultrasonic welding.

Clause 10. A security tag dispenser, comprising: a base; an axle extending from the base and configured to hold a spool having a string of a plurality of coupled security tags; a gripper assembly including a pivot member having a gripping flange and a supporting flange; wherein the gripping flange is configured to move between a first position configured to allow relative movement of the string of the plurality of coupled security tags, and a second position configured removably hold a second security tag of the string of coupled security tags; and wherein the supporting flange is configured support a first security tag adjacent to the second security tag on the string of the plurality of coupled security tags, and wherein the supporting flange is configured to transfer a portion of a tensile force applied to the first security tag to cause the gripping flange to move from the first position to the second position.

Clause 11. A security tag system, comprising: a plurality of security tags, each of the plurality of security tags comprising: a sleeve having a first tensile strength; and an inlay having a second tensile strength, the inlay being disposed movably within the sleeve and including: an antenna mounted on the inlay; and a radio frequency identifier (RFID) circuit coupled with the antenna; a first tab and a second tab each having a third tensile strength, wherein at least one of the first tab or the second tab is configured to detachably couple the security tag with an adjacent one of the plurality of security tags, wherein the first tensile strength is smaller than the second tensile strength and larger than the third tensile strength; and a security tag dispenser, comprising: a base; an axle extending from the base and configured to hold a spool having a string of the plurality of security tags; a gripper assembly including a pivot member having a gripping flange and a supporting flange; wherein the gripping flange is configured to move between a first position configured to allow relative movement of the string of the plurality of security tags, and a second position configured removably hold a second security tag of the string of the plurality of security tags; and wherein the supporting flange is configured support a first security tag adjacent to the second security tag on the string of the plurality of security tags, and wherein the supporting flange is configured to transfer a portion of a tensile force applied to the first security tag to cause the gripping flange to move from the first position to the second position.

Clause 12. The security tag system of clause 11, wherein a material of the sleeve includes one or more of polyethylene terephthalate, polyamide, cotton, polypropylene, acrylonitrile butadiene styrene, polystyrene, or polyethylene.

Clause 13. The security tag system of any preceding clause, wherein the material has a tensile strength between 10 and 70 Mega Pascal (MPa).

Clause 14. The security tag system of any preceding clause, wherein a material of the inlay includes one or more of polyester, polyimide, glass fiber, or polyamide.

Clause 15. The security tag system of any preceding clause, wherein the material has a tensile strength between 100 and 120 Mega Pascal (MPa).

Clause 16. The security tag system of any preceding clause, wherein a first material of the sleeve is a same material as a second material of the plurality of tabs.

Clause 17. The security tag system of any preceding clause, wherein a first width of the plurality of tabs is narrower than a second width of the plurality of security tags.

Clause 18. The security tag system of any preceding clause, wherein the third tensile strength between 9 and 11 Newtons (N).

Clause 19. The security tag system of any preceding clause, wherein the plurality of tabs are configured to couple to the plurality of security tags by ultrasonic welding.

Clause 20. The security tag system of any preceding clause, wherein the first material of the sleeve has a lower tensile strength than the second material of the inlay.

Clause 21. A method of making a plurality of security tags, comprising: placing a sensor on a length of material, wherein the sensor comprises an inlay, an antenna mounted on the inlay, and a radio frequency identifier (RFID) circuit coupled with the antenna, wherein the material comprises a fabric, wherein the sensor has a length extending from a first sensor end to an opposing second sensor end; folding a first lengthwise side of the material over to a second lengthwise side of the material to define a sleeve of the material having a top layer and a bottom layer, wherein the sensor is encompassed within the top layer and the bottom layer of the sleeve; affixing together the top layer to the bottom layer in a lengthwise lateral area where the first lengthwise side of the sleeve was folded over to the second lengthwise side of the sleeve; affixing together the top layer to the bottom layer in across a width of the sleeve at a first sleeve end and at a second sleeve end, wherein the first sleeve end is spaced apart from the first sensor end of the sensor, wherein the second sleeve end is spaced apart from a second sensor end of the sensor, and wherein the sensor is movable within the sleeve; and cutting the first sleeve end and the second sleeve end to define a security tag.

Clause 22. The method of the preceding clause, wherein a first material of the sleeve includes one or more of polyethylene terephthalate, polyamide, cotton, polypropylene, acrylonitrile butadiene styrene, polystyrene, or polyethylene.

Clause 23. The method of any of the preceding clauses, wherein a second material of the inlay includes one or more of polyester, polyimide, glass fibre, or polyamide.

Clause 24. The method of any of the preceding clauses, wherein the first material has a tensile strength between 10 and 70 Mega Pascal (MPa).

Clause 25. The method of any of the preceding clauses, wherein the second material has a tensile strength between 100 and 120 Mega Pascal (MPa).

Clause 26. The method of any of the preceding clauses, wherein the first material of the sleeve has a lower tensile strength than the second material of the inlay.

Clause 27. The method of any of the preceding clauses, the first material of the sleeve is a same material as a third material of a tab.

Clause 28. The method of any of the preceding clauses, wherein a first width of the tab is narrower than a second width of the tag.

Clause 29. The method of any of the preceding clauses, wherein the third tensile strength is between 9 and 11 Newtons (N).

Clause 30. The method of any of the preceding clauses, further comprising ultrasonically welding the tab to the tag.

Clause 31. A plurality of security tags, each of the plurality of security tags comprising: a sleeve having a first tensile strength; and an inlay having a second tensile strength, the inlay being disposed movably within the sleeve and including: an antenna mounted on the inlay; and a radio frequency identifier (RFID) circuit coupled with the antenna; and a plurality of tabs each having a third tensile strength, each of the plurality of tabs being configured to detachably couple opposing ends of two adjacent ones of the plurality of security tags; wherein the first tensile strength is smaller than the second tensile strength and larger than the third tensile strength.

Clause 32. The plurality of security tags of clause 1, wherein a material of the sleeve includes one or more of polyethylene terephthalate, polyamide, cotton, polypropylene, acrylonitrile butadiene styrene, polystyrene, or polyethylene.

Clause 33. The plurality of security tags of any preceding clause, wherein the material has a tensile strength between 10 and 70 Mega Pascal (MPa).

Clause 34. The plurality of security tags of clause 1, wherein a material of the inlay includes one or more of polyester, polyimide, glass fiber, or polyamide.

Clause 35. The plurality of security tags of any preceding clause, wherein the material has a tensile strength between 100 and 120 Mega Pascal (MPa).

Clause 36. The plurality of security tags of any preceding clause, wherein a first material of the sleeve is a same material as a second material of the plurality of tabs.

Clause 37. The plurality of security tags of any preceding clause, wherein a first width of the plurality of tabs is narrower than a second width of the plurality of security tags.

Clause 38. The plurality of security tags of any preceding clause, wherein the third tensile strength between 9 and 11 Newtons (N).

Clause 39. The plurality of security tags of any preceding clause, wherein the plurality of tabs are configured to couple to the plurality of security tags by ultrasonic welding.

Clause 40. A security tag dispenser, comprising: a base; an axle extending from the base and configured to hold a spool having a string of a plurality of coupled security tags; a gripper assembly including a pivot member having a gripping flange and a supporting flange; wherein the gripping flange is configured to move between a first position configured to allow relative movement of the string of the plurality of coupled security tags, and a second position configured removably hold a second security tag of the string of coupled security tags; and wherein the supporting flange is configured support a first security tag adjacent to the second security tag on the string of the plurality of coupled security tags, and wherein the supporting flange is configured to transfer a portion of a tensile force applied to the first security tag to cause the gripping flange to move from the first position to the second position.

Clause 41. A security tag system, comprising: a plurality of security tags, each of the plurality of security tags comprising: a sleeve having a first tensile strength; and an inlay having a second tensile strength, the inlay being disposed movably within the sleeve and including: an antenna mounted on the inlay; and a radio frequency identifier (RFID) circuit coupled with the antenna; a plurality of tabs each having a third tensile strength, each of the plurality of tabs being configured to detachably couple opposing ends of two adjacent ones of the plurality of security tags, wherein the first tensile strength is smaller than the second tensile strength and larger than the third tensile strength; and a security tag dispenser, comprising: a base; an axle extending from the base and configured to hold a spool having a string of the plurality of security tags; a gripper assembly including a pivot member having a gripping flange and a supporting flange; wherein the gripping flange is configured to move between a first position configured to allow relative movement of the string of the plurality of security tags, and a second position configured removably hold a second security tag of the string of the plurality of security tags; and wherein the supporting flange is configured support a first security tag adjacent to the second security tag on the string of the plurality of security tags, and wherein the supporting flange is configured to transfer a portion of a tensile force applied to the first security tag to cause the gripping flange to move from the first position to the second position.

Clause 42. The security tag system of clause 11, wherein a material of the sleeve includes one or more of polyethylene terephthalate, polyamide, cotton, polypropylene, acrylonitrile butadiene styrene, polystyrene, or polyethylene.

Clause 43. The security tag system of any preceding clause, wherein the material has a tensile strength between 10 and 70 Mega Pascal (MPa).

Clause 44. The security tag system of any preceding clause, wherein a material of the inlay includes one or more of polyester, polyimide, glass fiber, or polyamide.

Clause 45. The security tag system of any preceding clause, wherein the material has a tensile strength between 100 and 120 Mega Pascal (MPa).

Clause 46. The security tag system of any preceding clause, wherein a first material of the sleeve is a same material as a second material of the plurality of tabs.

Clause 47. The security tag system of any preceding clause, wherein a first width of the plurality of tabs is narrower than a second width of the plurality of security tags.

Clause 48. The security tag system of any preceding clause, wherein the third tensile strength between 9 and 11 Newtons (N).

Clause 49. The security tag system of any preceding clause, wherein the plurality of tabs are configured to couple to the plurality of security tags by ultrasonic welding.

Clause 50. The security tag system of any preceding clause, wherein the first material of the sleeve has a lower tensile strength than the second material of the inlay.

Clause 51. A method of making a plurality of security tags, comprising: placing a sensor on a length of material, wherein the sensor comprises an inlay, an antenna mounted on the inlay, and a radio frequency identifier (RFID) circuit coupled with the antenna, wherein the material comprises a fabric, wherein the sensor has a length extending from a first sensor end to an opposing second sensor end; folding a first lengthwise side of the material over to a second lengthwise side of the material to define a sleeve of the material having a top layer and a bottom layer, wherein the sensor is encompassed within the top layer and the bottom layer of the sleeve; affixing together the top layer to the bottom layer in a lengthwise lateral area where the first lengthwise side of the sleeve was folded over to the second lengthwise side of the sleeve; affixing together the top layer to the bottom layer in across a width of the sleeve at a first sleeve end and at a second sleeve end, wherein the first sleeve end is spaced apart from the first sensor end of the sensor, wherein the second sleeve end is spaced apart from a second sensor end of the sensor, and wherein the sensor is movable within the sleeve; and cutting the first sleeve end and the second sleeve end to define each of the plurality of security tags.

Clause 52. The method of the preceding clause, wherein a first material of the sleeve includes one or more of polyethylene terephthalate, polyamide, cotton, polypropylene, acrylonitrile butadiene styrene, polystyrene, or polyethylene.

Clause 53. The method of any of the preceding clauses, wherein a second material of the inlay includes one or more of polyester, polyimide, glass fibre, or polyamide.

Clause 54. The method of any of the preceding clauses, wherein the first material has a tensile strength between 10 and 70 Mega Pascal (MPa).

Clause 55. The method of any of the preceding clauses, wherein the second material has a tensile strength between 100 and 120 Mega Pascal (MPa).

Clause 56. The method of any of the preceding clauses, wherein the first material of the sleeve has a lower tensile strength than the second material of the inlay.

Clause 57. The method of any of the preceding clauses, wherein the first material of the sleeve is a same material as a third material of the plurality of tabs.

Clause 58. The method of any of the preceding clauses, wherein a first width of the plurality of tabs is narrower than a second width of the plurality of security tags.

Clause 59. The method of any of the preceding clauses, wherein the third tensile strength is between 9 and 11 Newtons (N).

Clause 60. The method of any of the preceding clauses, further comprising ultrasonically welding the plurality of tabs to the plurality of security tags.

Claim 61. The plurality of security tags of any one of the preceding clauses 1 to 9 and 31 to 39 can be used with the security tag dispenser of any one of the preceding clauses 10 and 40.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A security tag system, comprising:
a plurality of security tags, each of the plurality of security tags comprising:
a sleeve having a first tensile strength; and
an inlay having a second tensile strength, the inlay being disposed movably within the sleeve and including:
an antenna mounted on the inlay; and
a radio frequency identifier (RFID) circuit coupled with the antenna;
a first tab and a second tab of a plurality of tabs each having a third tensile strength, wherein at least one of the first tab or the second tab is configured to detachably couple a security tag with an adjacent one of the plurality of security tags, wherein the first tensile strength is smaller than the second tensile strength and larger than the third tensile strength; and
a security tag dispenser, comprising:
a base;
an axle extending from the base and configured to hold a spool having a string of the plurality of security tags; and
a gripper assembly including a pivot member having a gripping flange and a supporting flange;
wherein the gripping flange is configured to move between a first position configured to allow relative movement of the string of the plurality of security tags, and a second position configured removably hold a second security tag of the string of the plurality of security tags; and
wherein the supporting flange is configured support a first security tag adjacent to the second security tag on the string of the plurality of security tags, and wherein the supporting flange is configured to transfer a portion of a tensile force applied to the first security tag to cause the gripping flange to move from the first position to the second position.

2. The security tag system of claim 1, wherein a first material of the sleeve includes one or more of polyethylene terephthalate, polyamide, cotton, polypropylene, acrylonitrile butadiene styrene, polystyrene, or polyethylene.

3. The security tag system of claim 2, wherein the first material has a tensile strength between 10 and 70 Mega Pascal (MPa).

4. The security tag system of claim 2, wherein a second material of the inlay includes one or more of polyester, polyimide, glass fibre, or polyamide.

5. The security tag system of claim 4, wherein the second material has a tensile strength between 100 and 120 Mega Pascal (MPa).

6. The security tag system of claim 4, wherein the first material of the sleeve has a lower tensile strength than the second material of the inlay.

7. The security tag system of claim 2, wherein the first material of the sleeve is a same material as a third material of the plurality of tabs.

8. The security tag system of claim 1, wherein a first width of the plurality of tabs is narrower than a second width of the plurality of security tags.

9. The security tag system of claim 1, wherein the third tensile strength is between 9 and 11 Newtons (N).

10. The security tag system of claim 1, wherein the plurality of tabs are configured to couple to the plurality of security tags by ultrasonic welding.

11. A method of making a plurality of security tags, comprising:
placing a sensor on a length of material, wherein the sensor comprises an inlay, an antenna mounted on the inlay, and a radio frequency identifier (RFID) circuit coupled with the antenna, wherein the material comprises a fabric, wherein the sensor has a length extending from a first sensor end to an opposing second sensor end;
folding a first lengthwise side of the material over to a second lengthwise side of the material to define a sleeve of the material having a top layer and a bottom layer, wherein the sensor is encompassed within the top layer and the bottom layer of the sleeve;
affixing together the top layer to the bottom layer in a lengthwise lateral area where the first lengthwise side of the sleeve was folded over to the second lengthwise side of the sleeve;
affixing together the top layer to the bottom layer in across a width of the sleeve at a first sleeve end and at a second sleeve end, wherein the first sleeve end is spaced apart from the first sensor end of the sensor, wherein the second sleeve end is spaced apart from a second sensor end of the sensor, and wherein the sensor is movable within the sleeve; and
cutting the first sleeve end and the second sleeve end to define each of the plurality of security tags.

12. The method of claim 11, wherein a first material of the sleeve includes one or more of polyethylene terephthalate, polyamide, cotton, polypropylene, acrylonitrile butadiene styrene, polystyrene, or polyethylene.

13. The method of claim 12, wherein a second material of the inlay includes one or more of polyester, polyimide, glass fibre, or polyamide.

14. The method of claim 12, wherein the first material has a tensile strength between 10 and 70 Mega Pascal (MPa).

15. The method of claim 13, wherein the second material has a tensile strength between 100 and 120 Mega Pascal (MPa).

16. The method of claim 13, wherein the first material of the sleeve has a lower tensile strength than the second material of the inlay.

17. The method of claim 12, wherein the first material of the sleeve is a same material as a third material of a plurality of tabs.

18. The method of claim 17, wherein a first width of the plurality of tabs is narrower than a second width of the plurality of security tags.

19. The method of claim 17, further comprising ultrasonically welding the plurality of tabs to the plurality of security tags.

20. A security tag dispenser, comprising:
a base;
an axle extending from the base and configured to hold a spool having a string of a plurality of coupled security tags; and
a gripper assembly including a pivot member having a gripping flange and a supporting flange;
wherein the gripping flange is configured to move between a first position configured to allow relative movement of the string of the plurality of coupled security tags, and a second position configured removably hold a second security tag of the string of coupled security tags; and
wherein the supporting flange is configured support a first security tag adjacent to the second security tag on the string of the plurality of coupled security tags, and wherein the supporting flange is configured to transfer a portion of a tensile force applied to the first security tag to cause the gripping flange to move from the first position to the second position.
